(19) United States
(12) Patent Application Publication
(10) Pub. No.: US 2024/0380555 A1
(43) Pub. Date: Nov. 14, 2024

(54) POSITIONING OF USER EQUIPMENT (UE) USING REFERENCE SIGNALS

(71) Applicant: Apple Inc., Cupertino, CA (US)

(72) Inventors: Oghenekome OTERI, San Diego, CA (US); Haitong SUN, Cupertino, CA (US); Wei ZENG, Saratoga, CA (US); Dawei ZHANG, Saratoga, CA (US); Chunxuan YE, San Diego, CA (US)

(73) Assignee: Apple Inc., Cupertino, CA (US)

(21) Appl. No.: 18/633,395

(22) Filed: Apr. 11, 2024

Related U.S. Application Data
(60) Provisional application No. 63/501,642, filed on May 11, 2023.

(51) Int. Cl. H04L 5/00

(52) U.S. Cl. CPC H04L 5/0053

(57) ABSTRACT

The present application relates to devices and components including apparatus, systems, and methods for UE positioning. In an example, a UE transmits a sounding reference signal for positioning (SRSp) to a base station. The SRSp transmission can use frequency hopping and can rely on a window and/or a collision rule associated with the entire frequency hopping sequence or only a frequency hop of such a sequence. The window and/or collision rule can reduce the potential for signal collision with non-SRSp signals. Further, the UE can implement a low power high accuracy position (LPHAP) technique. In this technique, a fallback behavior or an SRSp transmission can be stopped if the UE is not able to accurately measure “N” configured reference signals, where “N” can be based on the positioning method.

### BACKGROUND

Cellular communications can be defined in various standards to enable communications between a user equipment and a cellular network. For example, Fifth generation mobile network (5G) is a wireless standard that aims to improve upon data transmission speed, reliability, availability, and more, as well as positioning of the user equipment.

### BRIEF DESCRIPTION OF THE DRAWINGS

FIG. 1 illustrates an example of a network environment, in accordance with some embodiments.

FIG. 2 illustrates an example of a transmission bandwidth and an effective positioning bandwidth of a user equipment (UE), in accordance with some embodiments.

FIG. 3 illustrates an example of using a partial positioning bandwidth, in accordance with some embodiments.

FIG. 4 illustrates another example of using a partial positioning bandwidth, in accordance with some embodiments.

FIG. 5 illustrates another example of using a partial positioning bandwidth, in accordance with some embodiments.

FIG. 6 illustrates an example of an operational flow/algorithmic structure that a receiver implements to feedback a positioning measurement(s), in accordance with some embodiments.

FIG. 7 illustrates an example of a window for sounding reference signal for positioning (SRSp) transmissions, in accordance with some embodiments.

FIG. 8 illustrates an example of windows for SRSp transmissions, in accordance with some embodiments.

FIG. 9 illustrates an example of parameters that define a window for an SRSp transmission, in accordance with some embodiments.

FIG. 10 illustrates an example of a collision rule for SRSp transmissions, in accordance with some embodiments.

FIG. 11 illustrates another example of a collision rule for SRSp transmissions, in accordance with some embodiments.

FIG. 12 illustrates an example of an operational flow/algorithmic structure for user equipment positioning, in accordance with some embodiments.

FIG. 13 illustrates an example of possibly using one or more spatial domain transmission filters for user equipment, in accordance with some embodiments.

FIG. 14 illustrates another example of an operational flow/algorithmic structure for user equipment positioning, in accordance with some embodiments.

FIG. 15 illustrates an example of receive components, in accordance with some embodiments.

FIG. 16 illustrates an example of a UE, in accordance with some embodiments.

FIG. 17 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) communicates with a base station of a network through one or more communication channels, where a base station can be referred to as a network node as well, such as an evolved Node B (eNB), a next generation node B (gNB), or other base station. The network can include a Fifth generation (5G) system, a New Radio (NR) system, a long term evolution (LTE) system, a combination thereof, or some other wireless systems. Reference signals, such as a positioning reference signal (PRS) on a downlink channel and a sounding reference signal for positioning (SRSp) on an uplink channel, can be communicated between the UE and the network (e.g., one or more base stations or one or more cells provided by a set of base stations) to estimate a position of the UE, where this position may be a geographical location with a certain accuracy.

In an example, the UE can have a particular bandwidth capability to transmit and/or receive such reference signals (e.g., a 20 MHz capability). To increase the positioning accuracy, a larger positioning bandwidth (e.g., 100 MHz) may be used, whereby the UE can implement frequency hopping to support the larger positioning bandwidth. In this example, several challenges may arise including, for instance, measurement reporting when the larger positioning bandwidth is only partially used (e.g., 80 MHz used instead of 100 MHZ, corresponding to four frequency hops instead of five), on-demand positioning and related signaling, and reception and/or transmission of other signals using the frequency hops (e.g., in case of signal collisions and the like). Various solutions to such challenges are described in the present disclosure.

In a further example, the UE can be configured with one or more spatial domain transmission filters. Various challenges associated with using such filters may also arise. For example, the UE can determine that the UE positioning using such filters may not be accurate enough. Various solutions to such challenges are also described in the present disclosure.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network node of a communications network, and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

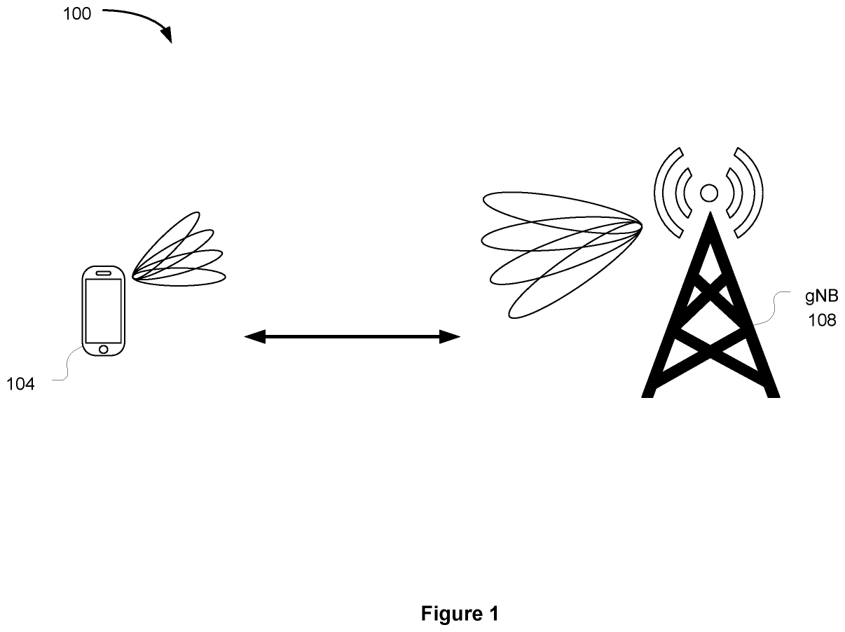

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications such as those that define Fifth Generation (5G) NR system standards.

The gNB 108 may transmit information (for example, data and control signaling) in the downlink direction by mapping logical channels on the transport channels, and transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure (including cell selection and reselection) and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include CSI reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

Transmissions that use different antenna ports may experience different radio channels. However, in some situations, different antenna ports may share common radio channel characteristics. For example, different antenna ports may have similar Doppler shifts, Doppler spreads, average delay, delay spread, or spatial receive parameters (for example, properties associated with a downlink received signal angle of arrival at a UE). Antenna ports that share one or more of these large-scale radio channel characteristics may be said to be quasi co-located (QCL) with one another. 3GPP has specified four types of QCL to indicate which particular channel characteristics are shared. In QCL Type A, antenna ports share Doppler shift, Doppler spread, average delay, and delay spread. In QCL Type B, antenna ports share Doppler shift and Doppler spread. In QCL Type C, antenna ports share Doppler shift and average delay. In QCL Type D, antenna ports share spatial receiver parameters.

The gNB 108 may provide transmission configuration indicator (TCI) state information to the UE 104 to indicate QCL relationships between antenna ports used for reference signals (for example, synchronization signal/PBCH or CSI-RS) and downlink data or control signaling, for example, PDSCH or PDCCH. The gNB 108 may use a combination of RRC signaling, MAC control element signaling, and DCI to inform the UE 104 of these QCL relationships.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1) band (between 40 Megahertz (MHz) and 7,125 MHz) and/or frequency range 2 (FR2) band (between 24,250 MHz and 52,600 MHZ). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

In an example, the UE 104 and the gNB 108 can communicate reference signals to position the UE 104 (e.g., to determine its geographical location, where this location can be absolute or relative to a position of the gNB 108). Various positioning methods are possible including triangulation techniques, time of arrival techniques, time of flight techniques, angle of arrival techniques, receiving signal strengths techniques, and the like. At least some of the positioning methods rely on reference signals communicating between the UE 104 and the gNB 108, and more specifically measurements performed on such reference signals. Example reference signals can include PRS on the downlink and SRS for positioning (SRSp) on the uplink. The use of PRS and SRSp are further described in the next figures. Nonetheless, the embodiments of the present disclosure may not be limited to only these two types of reference signals.

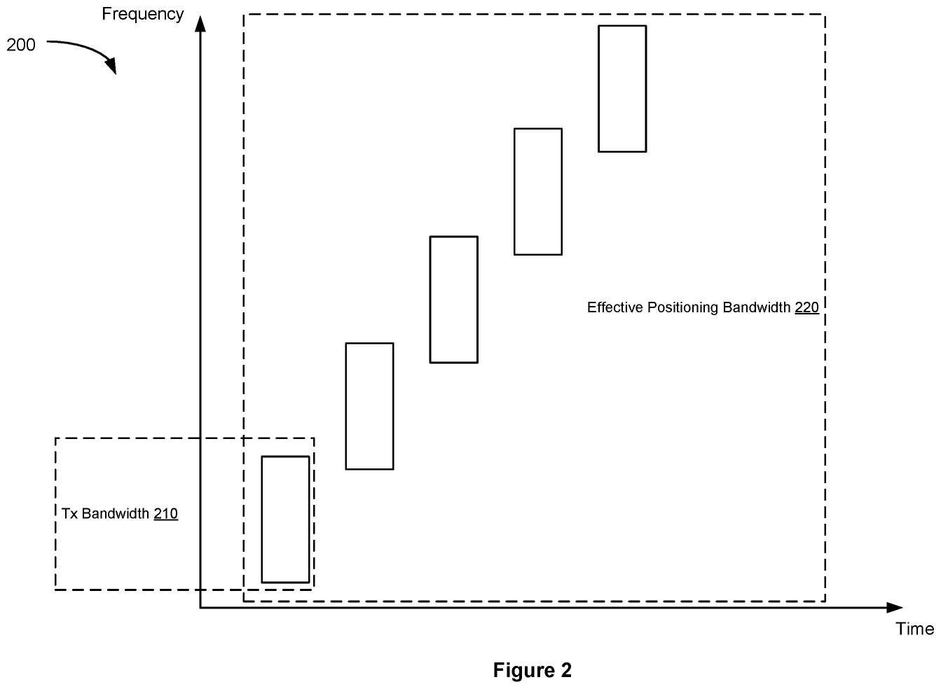

FIG. 2 illustrates an example 200 of a transmission bandwidth 210 and an effective positioning bandwidth 220 of a UE, in accordance with some embodiments. In the interest of clarity explanation, only the transmission bandwidth 210 is described. Nonetheless, the UE can have also a reception bandwidth, which may be the same or different than the transmission bandwidth 210. The description of the transmission bandwidth 210 and uses thereof in the context of UE positioning similarly and equivalently apply to the reception bandwidth. For the transmission bandwidth case, the transmitted signal is the SRSp from the UE and the reception device is the gNB. The gNB receives the SRSp, does the measurement and reports to a location management function (LMF). For the reception bandwidth case, the transmitted signal is the PRS from the gNB and the reception device is the UE. The UE receives the PRS, does the measurement and then reports to the LMF. For downlink, the gNB may transmit across the entire bandwidth and the UE receives what it can. For the uplink, the UE can only transmit on its entire bandwidth and hop. This difference in behavior is because the UE is the one that is bandwidth limited and when transmitting it is transmitting to one gNB with others hearing it. When the gNB transmits it typically is transmitting to multiple UEs with some UEs bandwidth limited and other UEs not.

In an example, the transmission bandwidth 210 depends on the capabilities of the UE (such as on the physical configuration of its transmit radio frequency (RF) chain). The UE can be a reduced capability (RedCap) UE having reduced capability relative to a non-RedCap UE. The reduced capability relates to a communication bandwidth (Tx and/or Rx bandwidths), reception branches, multiple input multiple output (MIMO) layers, a modulation order, and/or a duplex operation of the RedCap UE. The expected traffic amount for a RedCap UE is expected to be relatively lower than that of a non-RedCap UE, and the RedCap UE may be expected to have a lower battery consumption than the non-RedCap UE. As such, the RedCap UE typically has a smaller transmission bandwidth than a non-RedCap UE.

The UE (including a RedCap UE) can support frequency hopping such that a larger effective bandwidth can be achieved. For example, assume the transmission bandwidth to be 20 MHz. Also assume that the UE supports five frequency hops. In this case, an effective 100 MHz bandwidth can be achieved by using the five frequency hops. The frequency hopping can be used in the context of UE positioning, whereby PRS and/or SRSp transmissions can be spread over the multiple frequency hops to achieve an effective positioning bandwidth 220. This effective positioning bandwidth 220 is generally larger than the transmission bandwidth 210 (and/or the reception bandwidth of the UE). Typically, overlap is needed for signal processing to ensure phase coherency between the hops. So may be up to 6 hops needed.

Frequency hopping can be configured for the UE (including a RedCap UE) by, for example, a network (e.g., a base station thereof). The configuration can indicate a frequency hopping pattern and the associated parameters, such as the number of hopping subcarriers, the duration of each hop, and the hop sequence.

In the interest of clarity, the transmission of SRSp using the frequency hopping is further described herein next. In this case, a positioning measurement is generated by a network (e.g., a base station that receives the SRSp, or a location management function that provides this measurement to the base station). The positioning measurement is fed back or reported to the LMF. For SRSp, report is from gNB to LMF via NR Positionign Protocol a (NRPPa). As such, in the case of using the frequency hopping, different challenges exist including whether to feedback a single measurement for the effective positioning bandwidth 220 and/or a measurement per frequency hop. Similar challenge exist on downlink with the use of PRS, with feedback from UE to LMF via LTE positioning protocol (LPP).}. In addition, situations arise where not the full effective positioning bandwidth 220 is used (e.g., instead of all five frequency hops, four frequency hops are used for SRSp transmission by the UE or, on the base station side only SRSp transmission on the four frequency hops are received). Such situations also bring challenges in terms of the measurement feedback. Solutions to such challenges and related approaches are further described in the next figures.

The above challenges and solutions similarly and equivalently apply to PRS reception. In particular, the base station can either frequency hop or send full PRS bandwidth as it has full bandwidth radio. The UE needs to frequency hop on reception. On the reception side, the UE can use frequency hopping for the PRS reception, perform a positioning measurement, and feedback this measurement to the LMF. As such, challenges exist and relate to feeding back a single measurement for the full effective positioning bandwidth, feeding back a measurement per frequency hop, or feedback when only the effective positioning bandwidth is partially used. The solutions described in the context of SRSp transmission similarly and equivalently apply to the PRS reception.

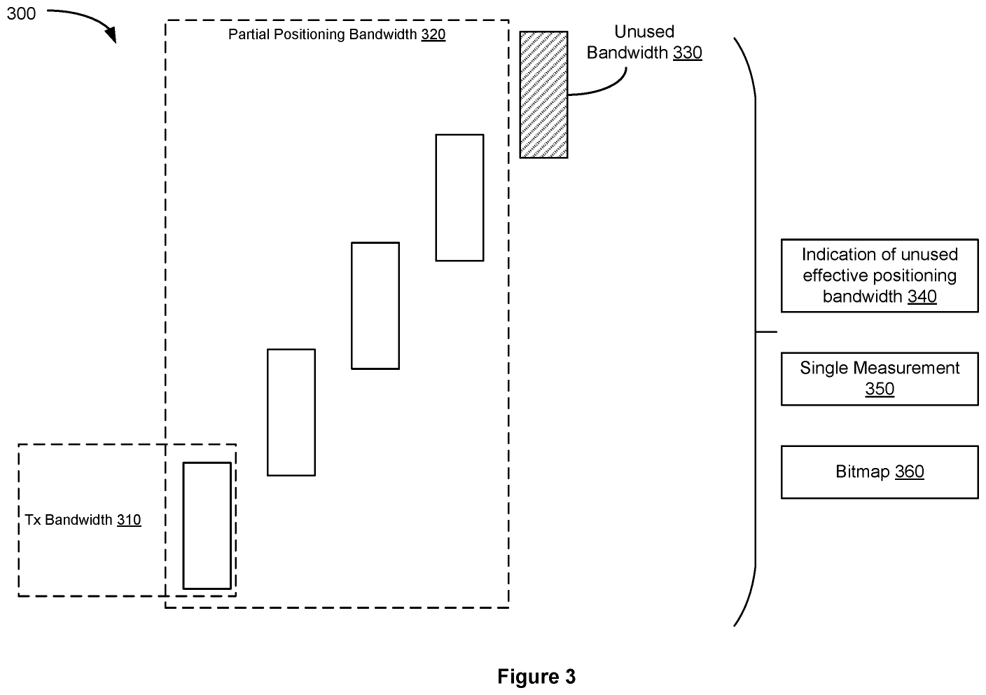

FIG. 3 illustrates an example of using a partial positioning bandwidth, in accordance with some embodiments. Here, a UE, such as a RedCap UE, has a transmission bandwidth 310 and is configured for frequency hopping. The frequency hopping is used for UE positioning, whereby PRS and/or SRS are transmitted to and/or from the UE using the configured frequency hops. As explained herein above, the SRSp transmission use case is described, whereby the UE transmits the SRSp, the gNB receives the SRSp and then reports the positioning measurement feedback to the LMF. Nonetheless, the techniques equivalently apply to the PRS reception use case, whereby the UE feeds back a positioning measurement to the LMF. Generally, the flow for PRS is as follows (1) the LMF configures the gNB to send PRS (e.g., by using NRPPa), (2) the LMF configures the UE to receive PRS (e.g., by using LPP), (3) the LMF configures enough PRS signals (E.g., over a larger bandwidth) for the UE to hop over the entire bandwidth with some overlap (4), the gNB configures the UE to receive PRS (e.g. by using RRC), (5) the gNB sends PRS, (6) the UE hops over the bandwidth, receives and measures PRS, and (7) the UE feeds back measurement to the LMF (e.g., by using LPP). In comparison, the flow for SRSp is as follows: (1) the LMF configures the gNB to receive SRSp (e.g., by using NRPPa), (2) the LMF configures the UE to send SRSp (e.g, by using LPP), (3) the LMF configures enough SRSp signals to for the UE to hop over an entire bandwidth with some overlap, (4) the gNB configures the UE for actual SRSp transmission signals (e.g., by using RRC), (5) the UE sends SRSp(s) and hops over bandwidth, (6) the gNB receives and measures SRSp over a larger bandwidth, and (7) the gNB feeds back/reports measurement to the LMF (e.g. by using NRPPa).

In particular, in the SRSp use case, the UE is the transmitter of a reference signal (e.g., SRSp) and the base station is the receiver of the reference signal. Subsequently, the base station is the transmitter of positioning measurement feedback, and the LMF is the receiver of the positioning measurement feedback. In comparison, in the PRS use case, the base station is the transmitter of a reference signal (e.g., PRS) and the UE is the receiver of the reference signal.

Subsequently, the UE is the transmitter of positioning measurement feedback, and the LMF is the receiver of the positioning measurement feedback. In both uses cases, the techniques described herein relate to transmitting the positioning measurement feedback (by the base station in the SRSp use case, or the UE in the PRS case) in light of the frequency hopping used in the reference signal transmission (by the UE in the SRSp use case, or the base station in the PRS ease).

Generally, the UE has a transmission bandwidth 310 and can be configured with frequency hopping parameters to achieve an effective positioning bandwidth that is larger than the transmission bandwidth 310. In one example, effective positioning bandwidth is fully used for SRSp transmission. In this example, the LMF receives positioning measurement feedback from the base station, where this feedback is based on the full effective positioning bandwidth. Different approaches exist for the positioning measurement feedback. In one example approach, the feedback includes only a single measurement corresponding to the full effective positioning bandwidth. In another example approach, the feedback includes a single measurement corresponding to the full effective positioning bandwidth and a per frequency hop measurement for all the frequency hops. In yet another example, a hybrid approach can be used. For instance, the feedback includes a single measurement corresponding to the full effective positioning bandwidth, a per frequency hop measurement for certain but not all the frequency hops, and/or a combined measurement that corresponds to two or more but not all of the frequency hops.

In an example, and as illustrated in FIG. 3, the effective positioning bandwidth is not fully used. For example, at least one of the frequency hops is unused (illustrated as an unused bandwidth 330 in FIG. 3). Different reasons can exist for such a situation. For instance, the UE may have used all the frequency hops for SRSp transmission, but the base station may have received the SRPs transmission on a subset of the frequency hops. In another illustration, the UE may have indeed used only the subset of the frequency hops for the SRSp transmission. Either way, only a partial positioning bandwidth 320 is used. This bandwidth 320 corresponds to the subset of frequency hops, is smaller than the full effective positioning bandwidth (corresponding to the full set of the frequency hops), and may be even equal to the transmission bandwidth 310.

In the example illustrated in FIG. 3, the feedback (e.g., sent by the base station in the SRSp use case, or equivalently sent by the UE in the PRS use case) includes an indication of unused effective positioning bandwidth 340. This indication 340 can inform the UE (or the base station in the PRS case) that the full effective positioning bandwidth was not used. For example, this indication can be a single bit, where a bit value can be set to indicate that the full effective positioning bandwidth was not used. It can also be a higher layer signal flag indicating success or failure. In addition, the feedback can include a single measurement 350 of the largest contiguous SRSp transmission (or, equivalently, the largest contiguous PRS transmission), along with a bitmap 360 that indicates the frequency hops that were combined to generate the single measurement 350 (e.g., the frequency hops corresponding to the largest contiguous transmission).

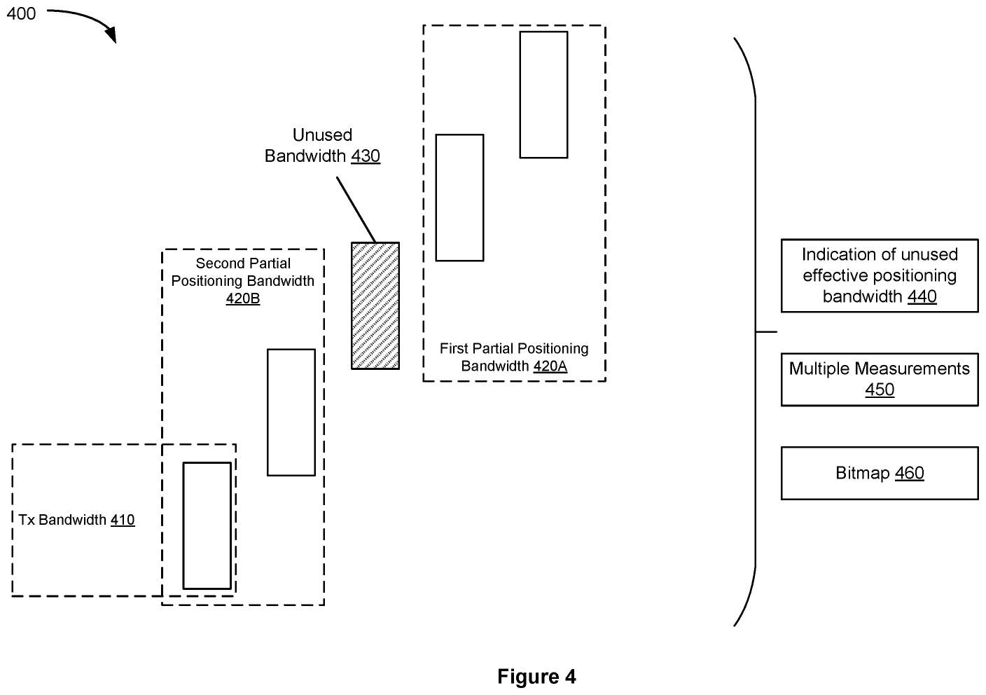

FIG. 4 illustrates another example 400 of using a partial positioning bandwidth, in accordance with some embodiments. A UE, such as a RedCap UE, has a transmission bandwidth 410 and is configured for frequency hopping to achieve an effective positioning bandwidth. However, and like in FIG. 3, the effective positioning bandwidth is not fully used. For example, at least one of the frequency hops is unused (illustrated as an unused bandwidth 430 in FIG. 4). As such, only a partial positioning bandwidth is used (illustrated as including a first partial positioning bandwidth 420A corresponding to the first two frequency hops and a second partial positioning bandwidth 420B corresponding to the next two other frequency hops).

In the example illustrated in FIG. 4, the feedback (e.g., sent by the base station in the SRSp use case, or equivalently sent by the UE in the PRS use case) includes an indication of unused effective positioning bandwidth 440. This indication 440 can be similar to the indication 340 of FIG. 3, thereby informing the UE (or the base station in the PRS case) that the full effective positioning bandwidth was not used. In addition, the feedback can include multiple measurements 350. Each of such measurements 350 can correspond to different contiguous SRSp transmissions (or, equivalently, different contiguous PRS transmissions). In the illustration of FIG. 4, two measurements are fed back, each corresponding to two contiguous frequency hops (e.g., a first measurement corresponding to the first partial positioning bandwidth 420A and a second measurement corresponding to the second partial positioning bandwidth 420B). In addition, the feedback includes signaling such as a bitmap 460 that indicates the frequency hops that were combined to generate the measurements 450 (e.g., indicating that the first two frequency hops were used to generate the first measurement and the next two frequency hops were used to generate the second measurement).

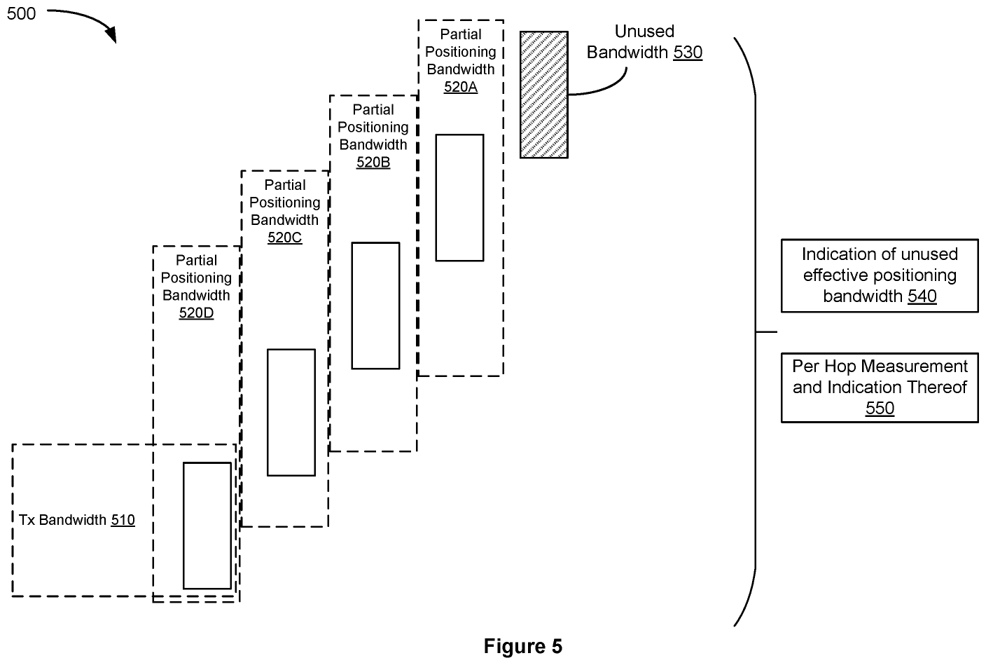

FIG. 5 illustrates another example 500 of using a partial positioning bandwidth, in accordance with some embodiments. A UE, such as a RedCap UE, has a transmission bandwidth 510 and is configured for frequency hopping to achieve an effective positioning bandwidth. However, and like in FIGS. 3-4, the effective positioning bandwidth is not fully used. For example, at least one of the frequency hops is unused (illustrated as an unused bandwidth 530 in FIG. 5). As such, only a partial positioning bandwidth is used (illustrated as including five partial positioning bandwidths 520A, 520B, 520C, and 520D each possibly being the same as the transmission bandwidth 510 and corresponding to the individual frequency hops).

In the example illustrated in FIG. 5, the feedback (e.g., sent by the base station in the SRSp use case, or equivalently sent by the UE in the PRS use case) includes an indication of unused effective positioning bandwidth 540. This indication 540 can be similar to the indication 340 of FIG. 3, thereby informing the UE (or the base station in the PRS case) that the full effective positioning bandwidth was not used. In addition, the feedback can include a per hop measurement and indication thereof 550. In particular, a positioning measurement can be generated per frequency hop and can be included in the feedback. Further, an index of a location of the measurement (e.g., an identifier of the frequency hop) can be included in the feedback. As such, upon receiving the feedback, the UE can determine the positioning measurement per frequency hop.

Referring back to FIGS. 3-5, in case the effective positioning bandwidth is partially used, different types of measurements that can be included in positioning measurement feedback are described. Additional or alternative approaches are also possible. For example, a fallback mode is defined and is used only when a partial positioning bandwidth is possible. For instance, if a failure in measurement of the full effective positioning bandwidth occurs, the fallback mode is then used. In an illustration, per hop measurements are fed back in the fall back mode with an option of signaling that the full effective positioning bandwidth was not used. Other possibilities exists, such as feeding back a combination or all of the measurements described in FIGS. 3-5 in the fallback mode.

In an example, a single measurement across multiple frequency hops is used in positioning measurement feedback (e.g., by the base station in the SRSp use case, or by the UE in the PRS use case). No feedback may be sent if there is a break (e.g., only a partial positioning bandwidth is available, or only non-contiguous frequency hops are available). Or, if there is a break, the feedback may be sent but may include an indication of whether the single measurement is value or not (e.g., an indication of being invalid the case of the break).

In another example, a single measurement across multiple frequency hops is used in positioning measurement feedback (e.g., by the base station in the SRSp use case, or by the UE in the PRS use case). Here, the single measurement can be based on a combination of frequency hops. In this example, the feedback includes an indication of the combined frequency hops. The indication can take the form of a bitmap. In particular, each frequency hop can be represented by a bit in the bitmap. A value (e.g., a “1”) of a bit representing a frequency hop can be used to indicate that the frequency hop is part of the combination.

In an example, multiple measurements are included in positioning measurement feedback (e.g., by the base station in the SRSp use case, or by the UE in the PRS use case), each corresponding to a combination of frequency hops. Here also, the feedback includes an indication of the combined frequency hops per measurement. The indication can take the form of a bitmap. In particular, each frequency hop can be represented by a bit in the bitmap. A value (e.g., a “1”) of a bit representing a frequency hop can be used to indicate that the frequency hop is part of the combination. Alternatively, each frequency hop can be represented by multiple bits in the bitmap. A default value (e.g., a “0 0” in a two bit representation) for a bit representation of a frequency hop can be used to indicate that the frequency hop is not part of any combination. Another value can represent the combination to which the frequency hop belongs (e.g., a “0 1” value indicates a first combination corresponding to a first measurement, whereas a “1 0” value indicates a second, different combination corresponding to a second measurement).

In an example, a per hop measurement is included in positioning measurement feedback (e.g., by the base station in the SRSp use case, or by the UE in the PRS use case) and corresponds to a single frequency hop. The per hop measurement(s) can be included, in the feedback, along with a single measurement across multiple frequency hops. Alternatively, or additionally, the per hop measurement(s) can be fed back in a fallback mode and/or by itself (e.g., based on an explicit measurement request from the UE in the SRSp use case or the base station in the PRS sue case). To assist in the per hop measurements, an indication of which received hops were measured and sent can be reported. Different options exist for this type of indication. In a first option, an indicator is sent per measured report (e.g., {M1, [1 0 0], M2 [0 1 0], M3, [0 0 1]}, where “Mi” corresponds to a per hop measurement, and [i j k] is a three-bit bitmap for three frequency hops, where a “1” value indicates that the measurement is for the corresponding frequency hop). In another option, an indicator is a bit map sent as a group, identifying all the hops measured {M1, M3, [1 0 1]}. In yet another example, the indicator is implicit and bitmap is not used. Instead, a “0” value for a measurement is reported to indicate that no per hop measurement was generated for the corresponding hop (e.g., {M1, 0, M3} indicates a per hop measurement for each of the first and third frequency hop, but that no per hop measurement was generated for the second frequency hop).

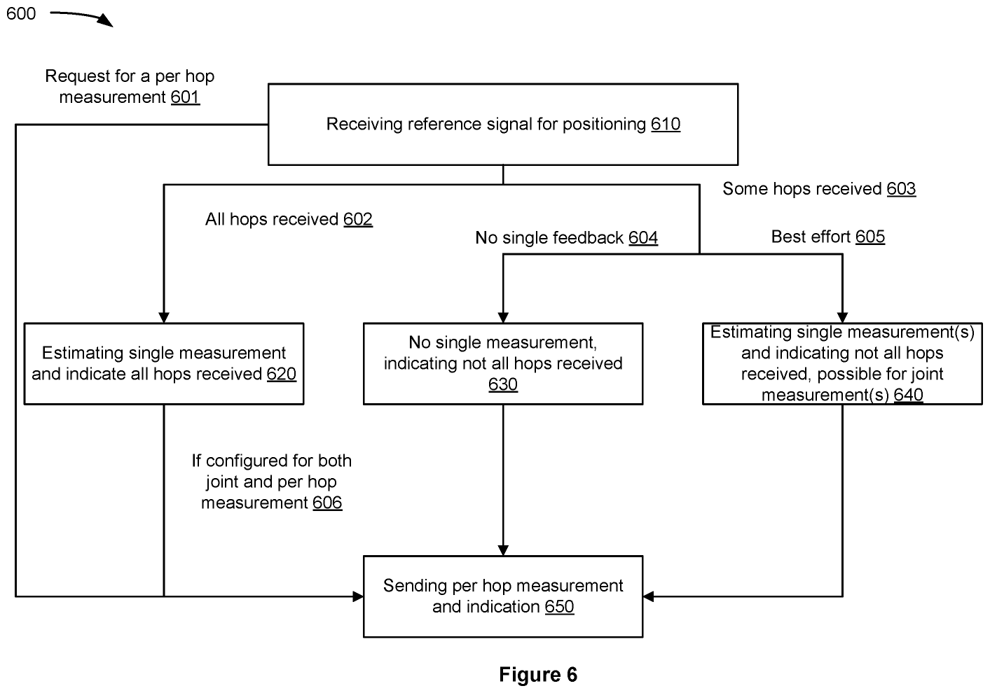

FIG. 6 illustrates an example of an operational flow/algorithmic structure 600 that a receiver implements to feedback a positioning measurement(s), in accordance with some embodiments. The receiver can be a component of a base station (e.g., in the use case of SRSp) or of a UE (e.g., in the use case of a UE). A reference signal for positioning is described in connection with operational flow/algorithmic structure 600 and can refer to SRSp, PRS, or any other type of reference signals that can be communicated between the base station and the UE and that can be used for UE positioning. The operational flow/algorithmic structure 600 includes multiple operations. Some of these operations may be implemented, while remaining ones can be omitted depending on whether a full bandwidth is used, a single measurement is desired, etc. Alternatively, all the operations are implemented, and specific ones are used depending on the specific situation (e.g., depending on whether the full bandwidth is received or not).

In an example, the operational flow/algorithmic structure 600 includes at, 610, receiving a reference signal for positioning. For instance, the reference signal can be received based on a reference signal transmission that uses frequency hops. In the particular SRSp use case, the UE (e.g., a RedCap UE) can use frequency hoping for SRSp transmission to achieve an effective positioning bandwidth larger than its transmission bandwidth. In the particular PRS use case, the base station can send multiple PRS transmissions with the UE frequency hopping to achieve an effective positioning bandwidth larger than the UE's reception bandwidth. If a request for a per hop measurement 601 is also received, operational flow/algorithmic structure 600 may proceed to operation 650. Otherwise, operation 620, 630, or 640 may follow operation 610. If all frequency hops 602 are received (e.g., the effective positioning bandwidth is fully used), operation 620 may follow operation 610. Otherwise, some of the frequency hops 603 (but not all) are received. In this case, either no single measurement feedback 604 is to be sent, and accordingly operation 630 may follow operation 610, or a best effort 605 is made to feedback measurements related to the received frequency hops and operation 640 may follow operation 610.

In an example, the operational flow/algorithmic structure 600 includes at, 620, estimating a single measurement and indicating that all hops are received. The single measurement can correspond to a combination of all the frequency hops such that being derived from the spreading of the reference signal across the full effective positioning bandwidth. The indication can be a single bit with a value (e.g., a “1”) set to indicate that the full effective positioning bandwidth was used. If the receiver is configured (or is requested) for both joint and per hop measurement 606, operation 650 may follow operation 620. In particular, and in addition to the single measurement, the receiver can also feedback one or more joint measurements corresponding to combined subsets of frequency hops and/or one or more per frequency hop measurements. In such situations, operation 650 may be performed to also feedback the one or more joint measurements and/or the one or more per frequency hop measurements, along with an indication(s) (e.g., bitmap(s) of the corresponding frequency hop(s).

In an example, the operational flow/algorithmic structure 600 includes at, 630, foregoing the generating of the single measurement because the only a partial positioning bandwidth is available. Here instead, an indication can be generated to indicate that not all frequency hops were received (e.g., not the full effective bandwidth was used). Operation 650 may follow operation 630. In this case, operation 650 can include sending the indication in the positioning measurement feedback (but not including a single measurement).

In an example, the operational flow/algorithmic structure 600 includes at, 640, estimating single measurement(s). For instance, a single measurement based on the largest contiguous transmission can be generate. In addition, an indication can be generated to indicate that not all frequency hops were received (e.g., not the full effective bandwidth was used). Further, the receiver can generate one or more joint measurements corresponding to combined subsets of frequency hops and/or, possible, one or more per frequency hop measurements. In such a case, the indication can indicate the corresponding frequency hops.

In an example, the operational flow/algorithmic structure 600 includes at, 650, sending per frequency hop measurements and indication identifying the corresponding frequency hops. Depending on the outputs of operations 620, 630, and 640, the operation 650 can also include sending such outputs in the positioning measurement feedback.

Referring back to FIGS. 2-6, and as explained herein above, PRS is an example of a downlink reference signal for positioning. An on-demand PRS transmission procedure can be used. In particular, this procedure allows a location management function (LMF) of a network to control and decide whether PRS is transmitted or not and to change the characteristics of an ongoing PRS transmission. The on-demand PRS transmission procedure can be initiated either by a UE or the LMF. The actual PRS changes are requested by the LMF irrespective of whether the on-demand PRS transmission procedure is UE or LMF-initiated.

Generally, the on-demand PRS transmission procedure includes many steps. For example, information is exchanged via an LTE positioning protocol (LPP) between the LMF and the UE and via an NR positioning protocol A (NRPPa) between an LMF and a base station (e.g., a gNB, or a transmission reception point (TRP) of a gNB). The information exchange can allow PRS configurations to be exchanged and on-demand PRS requests to be exchanged. A UE-initiated request can indicate a pre-defined PRS configuration identifier or an explicit PRS configuration parameter, a request for PRS transmission, and/or a change to PRS transmission characteristics. An LMF initiated request can be to obtain UE measurements and/or change PRS transmission characteristics.

As explained herein above, frequency hopping can be used in conjunction with UE positioning (e.g., in the use case of a RedCap UE but not limited to this type of UEs only). As such, the PRS configuration usable as part of the on-demand PRS transmission procedure can be updated to accommodate the need for frequency hopping.

In an example of updating a PRS configuration for frequency hopping, a determination can initially made that the effective positioning bandwidth is larger than a reception bandwidth of a UE. This determination can be made by the network (e.g., the LMF) and/or the UE. As such, the PRS configuration can be linked to the desired effective positioning bandwidth. This linking can be implicit using a one-to-one mapping. In other words, because frequency hopping is needed to achieve the desired effective positioning bandwidth, it can be implicitly determined that the PRS configuration needs to support the frequency hopping. Alternatively, rather than implicit linking, an explicit linking can be used. Here, an explicit mapping can be defined, where the number of frequency hops needed can be based on both the PRS configuration and the desired effective positioning bandwidth. The PRS configuration can be updated accordingly. For example, an information element (IE), such as NR-On-Demand-DL-PRS-Configurations IE can be updated. The NR-On-Demand-DL-PRS-Configurations IE provides a set of possible downlink PRS configurations which can be requested by a target device on-demand. The update here can indicate, among other things, an identifier of a downlink PRS configuration (as a desired configuration), whether frequency hopping for PRS is to be used or not (e.g., as a flag), and a bandwidth (e.g., an indication of the effective positioning bandwidth). For example, the NR-On-Demand-DL-PRS-Configurations IE can be defined as:

```
  On-Demand-DL-PRS-Configuration-r18 ::= SEQUENCE {
  Dl-prs-configuration-id-r18 DL-PRS-Configuration-ID-r18,
  # desired configuration
  PRS_hopping {0,1}
  nr-DL-PRS-PositioningFrequencyLayer-r17
  NR-DL-PRS-PositioningFrequencyLayer-r16,
  nr-DL-PRS-Info-r17 NR-DL-PRS-Info-r16,
  BW nr-DL-PFL_BW
  ...
}
```

In the above IE, “Dl-prs-configuration-id-r18” signals a desired configuration, “PRS_hopping” indicates not using frequency hopping (e.g., with a “0” value) or using frequency hopping (e.g., with a “1” value), and “BW” indicates the desired effective positioning bandwidth.

Further, an IE used in on-demand PRS request can be updated. An example IE is an NR-On-Demand-DL-PRS-Information IE. The IE NR-On-Demand-DL-PRS-Information defines the requested on-demand DL-PRS. This IE can incorporate the “PRS_hopping” and “BW” parameters.

Generally, various parameters can be indicated by an LMF-initiated request and/or UE-initiated request of an on-demand PRS. For a resource set per positioning frequency layer per frequency range (FR), the parameters can include downlink PRS periodicity, downlink PRS resource bandwidth, downlink resource repetition factor, number of downlink PRS resource symbols per downlink PRS resource, and downlink PRS comb size. In the case of the UE-initiated request, the parameters can further include the number of downlink frequency layers per FR and the start/end time of downlink PRS transmission per UE. In both types of requests, additional parameters related to the frequency hopping can be further included. These parameters include, for example, the overall desired effective positioning bandwidth, the frequency hop overlap between frequency hops, the number of frequency hops, whether intra-slot hopping is allowed or not, and/or whether inter-slot hopping is allowed or not.

In an example, frequency hopping is used for SRSp transmission by a UE. Because multiple frequency hops are used, a potential exists for signal collision between SRSp and non-SRSp signals (on the uplink and/or downlink). To mitigate such potential an uplink time window (shown herein below in the figures as a window and can be referred to as a window for an SRSp transmission) and/or a collision rule(s) (shown herein below in the figures as a collision rule and can be referred to as a collision rule for resolving a signal collision) can be used. The window can be an uplink time window where the UE is not expected to receiver and/or transmit other signals and/or channels and is only expected to transmit SRSp using frequency hopping. The collision rule can be associated with uplink SRSp with frequency hopping and other uplink and/or downlink channel and can specify, for example, relative priorities between such signals. The collision rule can allow transmission of a first signal (whether SRSp or otherwise) and prohibit transmission of a second signal (whether SRSp or otherwise) that would collide with the first signal (where at least one of the two signals is SRSp) based on relative priorities between such signals. The window and the collision rule can be used in conjunction with or alternate to each other.

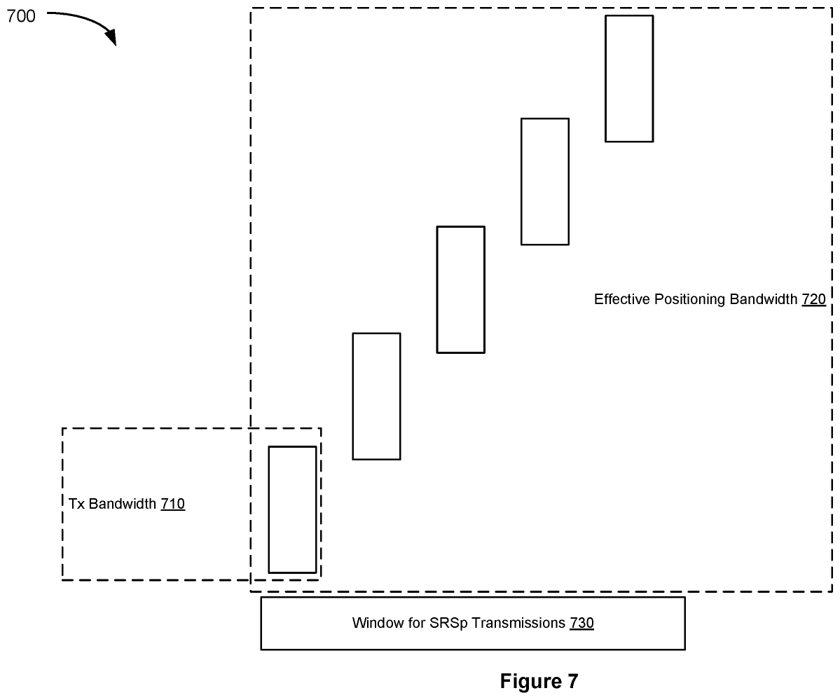

FIG. 7 illustrates an example of a window for SRSp transmissions 730, in accordance with some embodiments. As illustrated, a UE (e.g., a RedCap UE) can have a transmission bandwidth 710. An SRSp transmission can use frequency hopping such that the SRSp is transmitted using an effective positioning bandwidth 720 larger than the transmission bandwidth 710 (or, instead, possibly using a partial positioning bandwidth as described in the previous figures). The window for SRSp transmissions 730 can be defined (e.g., configured via signaling from the network) to span, in the time domain, the entire use of the frequency hop sequence that results in the effective positioning bandwidth (or at least the entire use of the partial positioning bandwidth).

In an example, the window 730 represents a time duration during which the transmission and/or reception of signals other than SRSp is not expected. During the time duration, the UE is only expected to transmit SRSp using frequency hopping. In a further example, the UE can be permitted to transmit SRSp using the frequency hops only during the window 730, such that the UE is prohibited from SRSp using the frequency hops outside of the window 730. In yet a further example, the UE can be permitted to transmit SRSp using the frequency hops during the window 730 (while no other signals are expected to be received or transmitted) and can be further permitted to transmit SRSp using the frequency hops outside of the window 730 (while other signals are expected to be received or transmitted; in this case, some signal prioritization may be used).

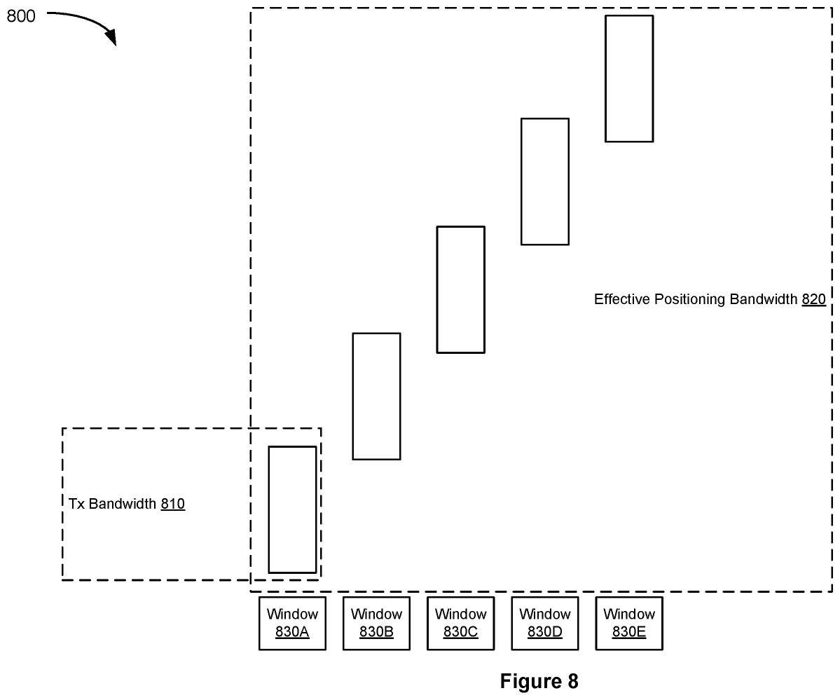

FIG. 8 illustrates an example of windows for SRSp transmissions, in accordance with some embodiments. As illustrated, a UE (e.g., a RedCap UE) can have a transmission bandwidth 810. An SRSp transmission can use frequency hopping such that the SRSp is transmitted using an effective positioning bandwidth 820 larger than the transmission bandwidth 810 (or, instead, possibly using a partial positioning bandwidth as described in the previous figures). Individual windows can be defined (e.g., configured via signaling from the network), where each window corresponds to a frequency hop of the plurality of frequency hops. A window corresponding to a frequency hop can span, in the time domain, the use of the frequency hop. In the illustration of FIG. 8, five frequency hops are shown (e.g., as blank rectangles). As such, five windows 830A, 830B, 830C, 830D, and 830E are defined and each corresponds to a different one of the frequency hop (e.g., window 830A corresponds to the first frequency hop, window 830B corresponds to the second frequency hop, window 830C corresponds to the third frequency hop, window 830D corresponds to the fourth frequency hop, and window 830E corresponds to the fifth frequency hop). In the interest of brevity, any of such windows 830A, 830B, 830C, 830D, and 830E can be referred as a window 830.

In an example, the window 830 represents a time duration during which the transmission and/or reception of signals other than SRSp is not expected. During the time duration, the UE is only expected to transmit SRSp using frequency hop. In a further example, the UE can be permitted to transmit SRSp using the frequency hop only during the window 830, such that the UE is prohibited from SRSp using the frequency hop outside of the window 830 (until the next frequency hop configured for the SRSp transmission). In yet a further example, the UE can be permitted to transmit SRSp using the frequency hop during the window 830 (while no other signals are expected to be received or transmitted, or with signals having a higher priority) and can be further permitted to transmit SRSp using the frequency hop outside of the window 830 (while other signals are expected to be received or transmitted).

Whereas FIG. 7 describes a window for the full effective bandwidth, and whereas FIG. 8 describes a window per frequency hop, embodiments of the present disclosure are not limited as such. For example, a window can be defined for a number of frequency hops (e.g., two or more) but not the entire frequency hop sequence. If multiple windows are defined across the frequency hop pattern, the time durations of these windows may but need not be the same.

Referring back to FIGS. 7 and 8, a window (e.g., the window 730 or any of the windows 830A through 830E) can be a configured window within which the UE is only expected to transmit FH SRS for positioning. The window can be configured by higher layer parameter, such as UL-SRS-FH-Window-Preconfig. In this parameter, an identifier can be indicated (e.g., ul-SRS-FH-Window-ID: preconfigured identifier (ID) for uplink SRS hopping window configuration), and/or a periodicity and offset of a starting slot can be indicated (e.g., ul-SRS-FH-PeriodicityandStartSlot: periodicity in slots and offset of starting slot with respect to system frame number (SFN) zero, slot number zero of a reference serving cell where uplink SRS (e.g., SRSp) is to be transmitted). The window may be valid for other cells that may be recipient of SRS (e.g., SRSp). The reference serving cell can be a primary cell or a cell (e.g., a secondary cell) configured as a reference for positioning. The values of the periodicity and/or offset can be sub-carrier spacing dependent. In also the parameter, a length of the window can be indicated. The length may be in slots. In such a case, the probability of dropping SRS is minimal (e.g., because the window spans at least a full slot). The length may be in sub-slots. In this case, the UE may have an opportunity to transmit other signals outside window and within a slot that contains the window. In yet another example, the length may be in symbols. Here also, the UE may have an opportunity to transmit other signals outside window and within a slot that contains the window. The length may be defined in specific time bases, such as gNSS, UTC time, etc.

Once the window is configured, different usage types are possible. In one example, uplink frequency hopping SRS may be only configured to transmit within window. In other words, the UE can transmit SRSp using frequency hopping only during the window. In another example, uplink frequency hopping SRS may be configured to transmit within and outside the window. In other words, the UE is not expected to transmit and/or receive using the frequency hops other signals during the window but is allowed to transmit SRSp using the frequency hopping during and outside the window.

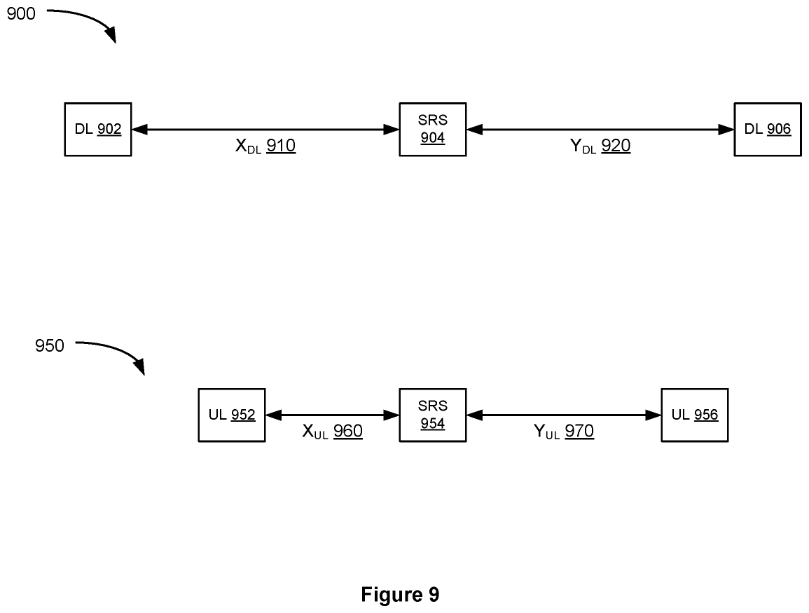

Generally, when using frequency hopping and a time window, because the UE is not expected to transmit and/or receive non-SRS signals during the window, signal collision can be avoided. To fine tune this signal collision avoidance, while also not reducing throughput (e.g., by defining the time duration of the time window to be longer than needed), the length of the time window can be set as an a number of symbols, where the start and the end can depend on a number of parameters such as bandwidth part switching, RF re-tuning, receive-to-transmit switch, and/or transmit-to-receive switch as further illustrated in FIG. 9.

FIG. 9 illustrates an example of parameters that define a window for an SRSp transmission, in accordance with some embodiments. A first example 900 is illustrated in the top half of FIG. 9, where a UE switches from reception to transmission to transmit SRS and then switches to reception. A second example 950 is illustrated in the bottom half of FIG. 9, where the UE does not perform the downlink to uplink switch and vice versa. Of course, other examples likewise exist, such as when the UE switches from downlink to uplink but not to downlink immediately thereafter, or when the UE is in the uplink transmission, transmits SRS, and then switches to downlink reception.

As illustrated in the first example 900, the UE receives a signal on the downlink 902. Thereafter, the UE switches to transmit SRS 904 for positioning, where this transmission uses frequency hopping. And immediately after the SRS transmission 904, the UE switches back to receiving a signal on the downlink 906. To do so, the first switch involves bandwidth part switching, RF re-tuning, and receive to transmit chain switching. The length of the first switch is X_{DL} symbols 910 (e.g., a first time duration defined in a number of symbols) before the SRS transmission 904 (e.g., before a start of this transmission 904, where the start can be at a particular symbol), where X_{DL} is a positive integer. The second switch involves bandwidth part switching, RF re-tuning, and transmit to receive chain switching. The length of the second switch is Y_{DL} symbols 920 (e.g., a second time duration defined in a number of symbols) after the SRS transmission 904 (e.g., after the end of this transmission 904, where the end can be at a particular symbol), where Y_{DL} is a positive integer. As such, an uplink frequency hopping SRS instance collides with another downlink signal or channel if any if any portion of the other another downlink signal or channel overlaps with the time interval starting X_{DL} symbols 910 before the SRS 904 transmission and ending Y_{DL} symbols 920 after the SRS transmission 904. As such, in this example, the window can be defined to start at X_{DL} symbols 910 before the SRS 904 transmission and end at Y_{DL} symbols 920 after the SRS transmission 904.

As illustrated in the second example 950, the UE transmits a signal on the uplink 952. Thereafter, the UE uses a different bandwidth part to transmit SRS 954 for positioning, where this transmission uses frequency hopping. And immediately after the SRS transmission 954, the UE uses another bandwidth part on uplink 956. To do so, the UE also performs two switches. The first switch involves bandwidth part switching and RF re-tuning. The length of the first switch is X_{UL} symbols 960 (e.g., a first time duration defined in a number of symbols) before the SRS transmission 954 (e.g., before a start of this transmission 954, where the start can be at a particular symbol), where X_{UL} is a positive integer. The second switch involves bandwidth part switching and RF re-tuning. The length of the second switch is Y_{UL} symbols 970 (e.g., a second time duration defined in a number of symbols) after the SRS transmission 954 (e.g., after the end of this transmission 954, where the end can be at a particular symbol), where You is a positive integer. As such, an uplink frequency hopping SRS instance collides with another uplink signal or channel if any if any portion of the other uplink signal or channel overlaps with the time interval starting X_{UL} symbols 960 before the SRS 954 transmission and ending Y_{UL} symbols 970 after the SRS transmission 954. As such, in this example, the window can be defined to start at X_{UL} symbols 960 before the SRS 954 transmission and end at Y_{UL} symbols 970 after the SRS transmission 954.

In an example, X and Y (representing a first number of symbols prior to SRS transmission using frequency hopping and a second number of symbols after such an SRS transmission using frequency, respectively and corresponding to X_{DL} and/or X_{UL} and Y_{DL} and/or Y_{UL} above) can be sub-carrier depending. Further, X and Y can be different for downlink symbols/channels and uplink symbols/channels (e.g., X_{DL} can be different from X_{UL} and/or Y_{DL} can be different from Y_{UL}). X and Y can also be different from each other (or may be equal) and each may be based on the UE capability related to the needed switch. In an example, the configuration of the window can include definitions (e.g., values) for X and Y (e.g., these two parameters can be configured via high layer signaling).

As such, at X symbols before a start of SRSp transmission using frequency hopping, the UE is not expected to receive and/or process downlink symbols and/or transmit and/or process uplink symbols. As such, the reception, processing, and/or transmission of such symbols can be foregone. Similarly, at Y symbols after an end of SRSp transmission using frequency hopping, the UE is not expected to receive and/or process downlink symbols and/or transmit and/or process uplink symbols. As such, the reception, processing, and/or transmission of such symbols can be foregone.

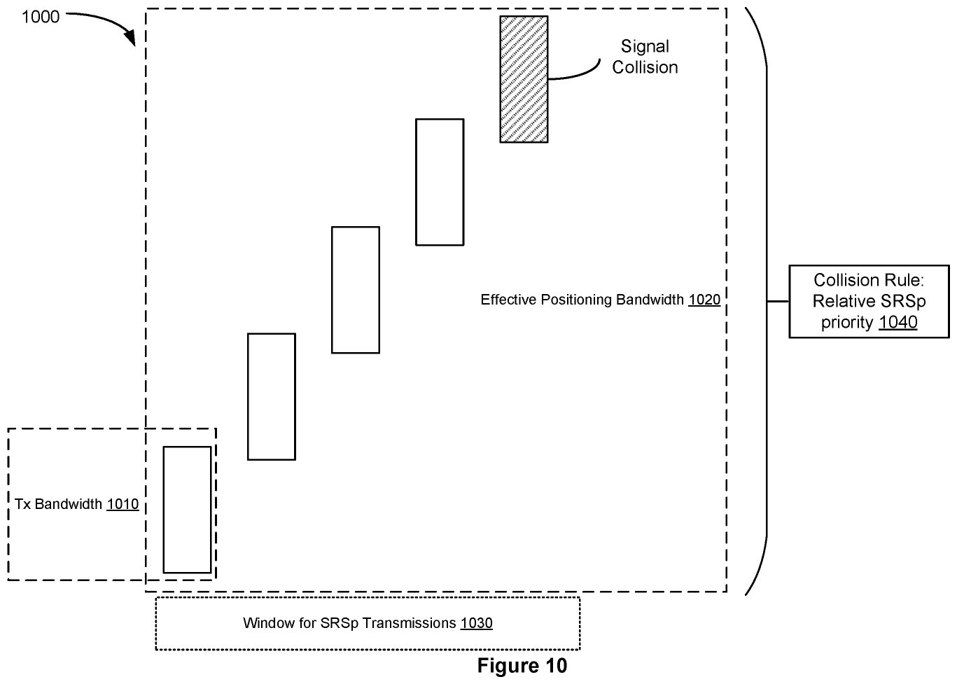

FIG. 10 illustrates an example of a collision rule for SRSp transmissions, in accordance with some embodiments. As illustrated, a UE (e.g., a RedCap UE) can have a transmission bandwidth 1010. An SRSp transmission can use frequency hopping such that the SRSp is transmitted using an effective positioning bandwidth 1020 larger than the transmission bandwidth 1010 (or, instead, possibly using a partial positioning bandwidth as described in the previous figures). A collision rule 1040 can be associated with the SRSp transmission when using multiple frequency hops. In particular, the collision rule 1040 can indicate a priority (ies) of the SRSp and other signals such that a relative priority (ies) between the signals can be determined (e.g., a relative priority of the SRSp relative to any of the other signals). When using the frequency hopping for the SRSp transmission, upon a collision between the SRSp transmission and the reception and/or transmission of any other signal using the frequency hops, the collision rule 1040 allows certain transmission(s) and/or reception(s) based on the relative priorities. For example, the SRSp transmission may have the highest priority such that the SRSp transmission is allowed.

In a further example, and as shown with a dotted line, the collision rule 1040 can be used a standalone rule (e.g., independent of a window for SRSp transmissions 1030) or in combination with the window for SRSp transmissions 1030. As a standalone rule, the window 1030 not be configured or, if configured, need not be used. If in combination, the collision rule 1040 applies to the SRSp transmission during the window 1030 only and may not apply to SRSp transmission, if any, outside the window 1030.

In the illustration of FIG. 10, the collision rule 1040 applies to the entire frequency hopping sequence. That is, if a signal collision exists in any of the frequency hops, the collision rule 1040 can prioritize the SRSp transmission across the entire frequency hopping sequence. For instance, assume that a signal collision occurs in one of the frequency hops, shown in FIG. 10 with the diagonally dashed rectangle. The collision rule 1040 allows only the SRSp transmission when a signal collision exists. As such, because a signal collision exists in one of the frequency hops of the frequency hop sequence, no signal other SRSp can be transmitted (or received) using the frequency hop sequence.

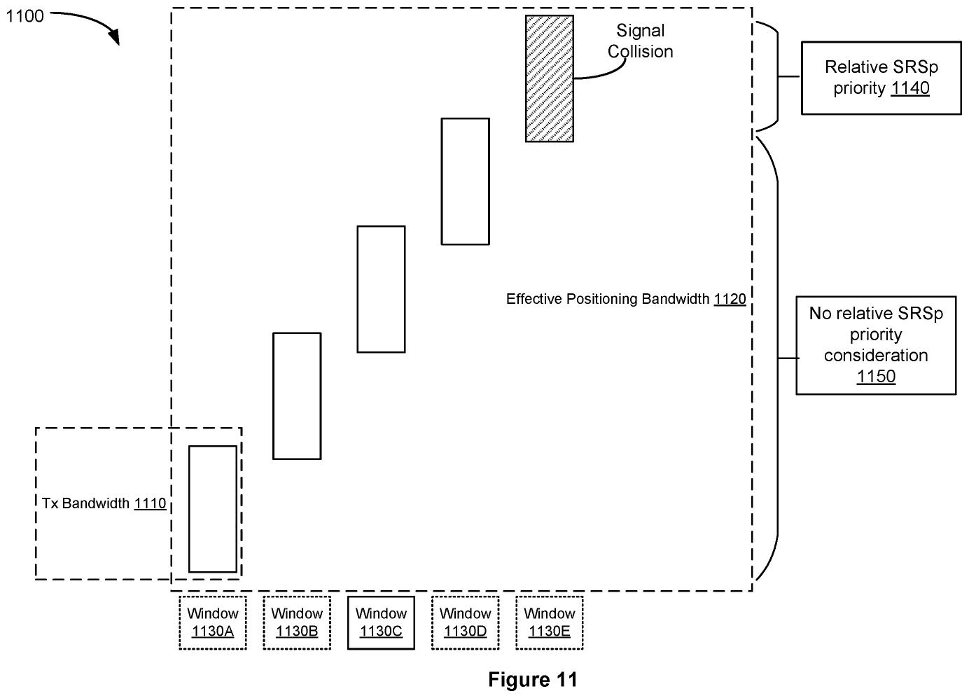

FIG. 11 illustrates another example of a collision rule for SRSp transmissions, in accordance with some embodiments. Here also, a UE (e.g., a RedCap UE) can have a transmission bandwidth 1110. An SRSp transmission can use frequency hopping such that the SRSp is transmitted using an effective positioning bandwidth 1120 larger than the transmission bandwidth 1110 (or, instead, possibly using a partial positioning bandwidth as described in the previous figures). A collision rule can be associated with the SRSp transmission when using multiple frequency hops. In particular, the collision rule can indicate a priority (ies) of the SRSp and other signals such that a relative priority (ies) between the signals can be determined (e.g., a relative priority of the SRSp relative to any of the other signals). When using the frequency hopping for the SRSp transmission, upon a collision between the SRSp transmission and the reception and/or transmission of any other signal using a frequency hop of the frequency hop sequency, the collision rule attaches to only the frequency hop where the signal collision occurs. Attachment indicates that the collision rule allows certain transmission(s) and/or reception(s) using the frequency hop based on the relative priorities, but such constraints do not apply to other frequency hops of the frequency hop sequence where no signal collision exists.

In the illustration of FIG. 11, assume that a signal collision occurs in one of the frequency hops, shown with the diagonally dashed rectangle. The collision rule allows only the SRSp transmission during the frequency hop if a signal collision exists when that frequency hop is used and attaches to only that frequency hop. As such, because a signal collision exists in one particular frequency hop, that frequency hop is only allowed to be used for the SRSp transmission (assuming that the SRSp has relatively the highest priority 1140). However, no constraint is imposed due to this signal collision on the use of any of the other frequency hops of the frequency hop sequence (shown in FIG. 11 as no relative priority of the SRSp is considered 1150 in these other frequency hops).

In a further example, and as shown with a dotted line, the collision rule can be used a standalone rule (e.g., independent of a window for SRSp transmissions) or in combination with individual windows 1130A, 1130B, 1130C, 1130D, and 1130E each corresponding to a frequency hop. As a standalone rule, the windows 1130A through 1130E not be configured or, if configured, need not be used. If in combination, the collision rule applies to the SRSp transmission during a particular window 1130A, 1130B, 1130C, 1130D, or 1130E only.

Although individual windows corresponding to different frequency hops are illustrated in FIG. 11, such windows can be used in combination with the collision rule 1040 of FIG. 10. Conversely, the window 1030 spanning the entire frequency hop sequence can be used with the collision rule of FIG. 11.

Referring back to FIGS. 10-11, a signal collision occurs when uplink frequency hopping SRS instance collides with a downlink signal/channel and/or an uplink signal/channel if any portion of the other downlink signal/channel and/or the uplink signal/channel overlaps with the time interval starting X symbols before the SRSp transmission and ending Y symbols after the transmission. The X symbols and the Y symbols can be defined as described herein above. Here also, X_{DL} and X_{UL} of FIG. 9 are examples of X, and Y_{DL} and Y_{UL} of FIG. 9 are examples of Y. In particular, X and Y can depend on active bandwidth part re-tuning, fast retuning of RF frequency, and transmit and receive channel switching, as described in FIG. 9. As far as active bandwidth part re-tuning, X and Y may depend on if the uplink and/or downlink signals are transmitted in the hopped frequency or in the frequency of the active bandwidth part. This depends on if the active bandwidth part for communications stays the same over the frequency hops, or if the active bandwidth part changes with the frequency hops. As far as fast retuning of RF frequency, X and Y may depend on fast retuning of the RF to the active communications bandwidth part if the active bandwidth part for communications stays the same or not. As far as transmit and receive channel switching, for downlink channels, X and Y may depend on the transmit and receive switching time to enable the UE to switch from reception (downlink channel reception) to transmission (uplink channel transmission) and vice versa. This may be specified in a technical specification with which the UE is compatible and/or may depend on UE capability given that UEs can have varying complexity. For uplink channels, the effect of reception and transmit switching can be ignored.

Transmission of uplink frequency hopping SRS can depend on the relative priority of colliding signals and channel. As illustrated in FIG. 11, upon a signal collision, the uplink frequency hopping SRS can be transmitted (when it has a higher priority relative to the other colliding signal, and the other signal dropped) or dropped (when the relative priority is lower, and the other signal is transmitted) if the signal collision occurs on a specific frequency hop. In comparison, as illustrated in FIG. 10, the collision rule is a total bandwidth collision rule. In particular, all uplink frequency hopping SRSs are dropped if collision occurs on any of the frequency hops (when an uplink frequency hopping SRS has a higher priority relative to the other colliding signal, and the other signals dropped during the frequency hopping sequence) or transmitted (when the uplink frequency hopping SRS has a higher priority relative to the other colliding signal, and the other signals transmitted during the frequency hopping sequence).

The collision rule can be priority-based. In particular, this rule can indicate a relative priority of the uplink frequency hopping SRS compared with other downlink and uplink signals. In one example, no distinction is made between uplink and downlink and a same set of priorities is defined. In another example, a distinction is made between uplink and downlink and one set of priorities is defined for the uplink and a different set of priorities is defined for the downlink. Table 1 below illustrates the use of two different sets of priorities.

TABLE 1

| Downlink | | Uplink | |
|---|---|---|---|
| Pd1 | SRS has priority above all DL signals | Pu1 | SRS has priority above all UL |
| | and channels | | channels |
| Pd2 | Lower than SSB | Pu2 | Lower than PRACH |
| Pd3 | Lower priority than SSB and PDCCH | Pu3 | Lower than PRACH and |
| | and the PDSCH scheduled by DCI | | PUCCH/PUSCH with larger priority |
| | formats 1_1 or 1_2 with the priority | | value |
| | indicator field in the corresponding | | |
| | DCI format set to 1, and is higher | | |
| | priority than other DL signals | | |
| Pd4 | Lower priority than all the DL signals | Pu4 | Lower priority than all the UL signals |
| | and channels | | and channels |

In Table 1 above, any of the indicators Pd1 through Pd4 can be set for the uplink frequency hopping SRS to define its relative priority to downlink. Similarly, any of the indicators Pu1 through Pu4 of Table 1 can be set for the uplink frequency hopping SRS to define its relative priority to the uplink.

In an example, relative priority of the uplink frequency hopping SRS compared with other downlink and uplink signals can configurable based on higher layer signaling. For example, higher layer signaling, such as RRC signaling, can set a relative priority for the uplink frequency hopping SRS relative to all downlink signals (e.g., PDCCH/PDSCH/CSI-RS) and/or relative to all other uplink signals (e.g., PRACH/PUCCH/PUSCH). Other signaling may be possible, such as LPP.

In another example, rather than being configured via higher layer signaling, the relative priority (ies) can be predefined. This can be similar to the priorities defined for carrier aggregation. The predefinition can be specified in a technical specification with which the UE is compatible and/or may be a UE specific implementation. In an example, for uplink, PRACH, PUCCH/PUSCH have larger priority value, PUCCH/PUSCH have the same priority index, SRS transmission with aperiodic SRS has a higher priority than SPS or periodic SRS. Uplink frequency hopping SRS can be placed at a position somewhere within this hierarchy. On the downlink, SSB has a higher priority than PDCCH that has a higher priority than PSDCH that has a higher priority than CSI-RS. Uplink frequency hopping SRS can be placed at a position somewhere within this hierarchy.

In an example of a procedure for using a collision rule, a UE determines uplink frequency hopping collision parameters. Such parameters include X, Y, and/or priority (e.g., relative priority indicator as shown in Table 1) and can be predefined or configured via higher layer signaling. If the collision parameters are determined for a frequency hop (e.g., as in the collision rule of FIG. 11), at X symbols before transmission (e.g., within a first time duration prior to a start of an SRSp transmission that uses the frequency hop), the UE performs priority analysis of all signals/channels for the single frequency hop. The UE then can transmit the signal(s) that has highest priority (in case of signal collision that would occur for using the frequency hop, the UE can drop an uplink frequency hopping SRS if it does not have the highest priority or can transmit it otherwise and drop the other colliding, lower priority signal). If the collision parameters are determined for an entire frequency hopping sequence (e.g., as in the collision rule of FIG. 10), at X symbols before transmission (e.g., within a first time duration prior to a start of an SRSp transmission that uses the frequency hop sequence), the UE performs priority analysis of all the signals/channels for all frequency hops. Here, the UE can transmit uplink frequency hopping SRS for all frequency hops if this SRS has highest priority.

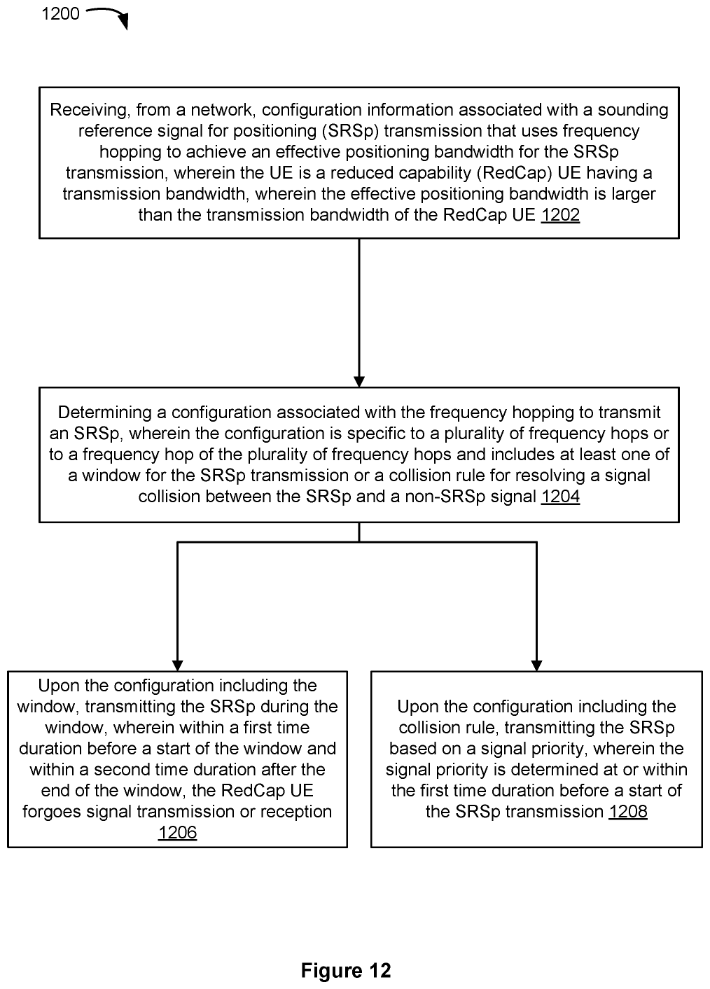

FIG. 12 illustrates an example of an operational flow/algorithmic structure 1200 for user equipment positioning, in accordance with some embodiments. The operational flow/algorithmic structure 1200 can be implemented by a UE, such as any of the UEs described herein, for the transmission of SRS for positioning, where the transmission uses frequency hopping.

In an example, the operational flow/algorithmic structure 1200 includes, at 1202, receiving, from a network, configuration information associated with a sounding reference signal for positioning (SRSp) transmission that uses frequency hopping to achieve an effective positioning bandwidth for the SRSp transmission, wherein the UE is a reduced capability (RedCap) UE having a transmission bandwidth, wherein the effective positioning bandwidth is larger than the transmission bandwidth of the RedCap UE.

In an example, the operational flow/algorithmic structure 1200 includes, at 1204, determining a configuration associated with the frequency hopping to transmit an SRSp, wherein the configuration is specific to a plurality of frequency hops or to a frequency hop of the plurality of frequency hops and includes at least one of a window for the SRSp transmission or a collision rule for resolving a signal collision between the SRSp and a non-SRSp signal. The configuration can be specified in the configuration information (e.g., signaled by higher layer signaling) or predefined. The configuration information can configure the SRSp transmission and can include, for example, indications of X, Y, priority, and the like.

Based on the configuration, at least one of operation 1206 or operation 1208 is performed. In particular, if the configuration only includes the window, only operation 1206 is performed. Conversely, if the configuration only includes the collision rule, only operation 1208 is performed. However, if the configuration only includes both the window and the collision rule, both operation 1206 and operation 1208 are performed.

In an example, the operational flow/algorithmic structure 1200 includes, at 1206, upon the configuration including the window, transmitting the SRSp during the window, wherein within a first time duration before a start of the window and within a second time duration after the end of the window, the RedCap UE forgoes signal transmission or reception. The first time duration can start at X symbols prior to the SRSp transmission. The second time duration can end at Y symbols after the SRSp transmission.

In an example, the operational flow/algorithmic structure 1200 includes, at 1208, upon the configuration including the collision rule, transmitting the SRSp based on a signal priority, wherein the signal priority is determined at or within the first time duration before a start of the SRSp transmission.

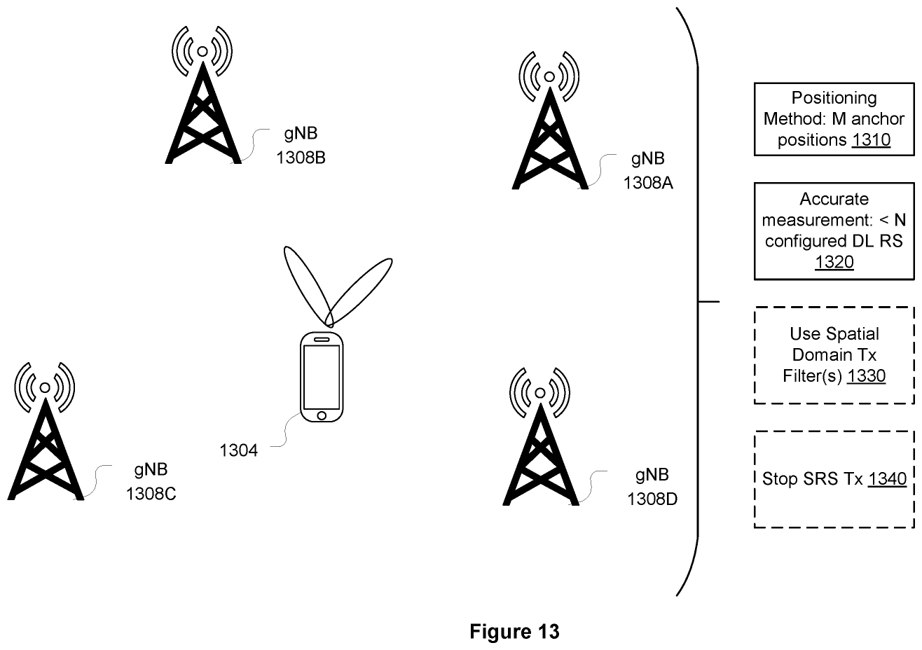

FIG. 13 illustrates an example of possibly using one or more spatial domain transmission filters for user equipment, in accordance with some embodiments. A UE 1304, such as an industrial internet of things (IoT) device or any other type of devices, can implement low power high accuracy positioning (LPHAP) techniques. The UE 1304 can be configured with spatial relation information indicating one or more spatial domain filters (e.g., used for beam forming) for transmission of SRS in support of UE positioning using a positioning method. The spatial relation information can be configuration information specified by a higher layer parameter, such as spatialRelationInfoPos.

When the UE 1304 is in an RRC_CONNECTED state, the following UE behavior can be specified. If the UE is not configured with the higher layer parameter spatialRelationInfoPos, the UE 1304 may use a fixed spatial domain transmission filter for transmissions of the SRS configured by the higher layer parameter SRSPosResource across multiple SRS resources, or the UE 1304 may use a different spatial domain transmission filter across multiple SRS resources.

When the UE 1304 is in an RRC_INACTIVE state, validity criteria of spatial for SRS transmission and the following UE behavior can be specified. If the UE 1304 is in the RRC_INACTIVE state and determines that the UE 1304 is not able to accurately measure the configured downlink reference signal in SRS-SpatialRelationInfoPos for an SRS resource for positioning, where the downlink reference signal is semi-persistent or periodic, the UE 1304 stops transmission of the SRS resource for positioning.

Further, when the UE 1304 is in an RRC_INACTIVE state, the following UE behavior can be possible for the spatial relation of an SRS for positioning configuration in multiple cells. When the spatial relation information is absent in the configuration, the UE 1304 may use a fixed spatial domain transmission filter for transmissions of the SRS configured by the higher layer parameter SRS-PosResource across multiple SRS resources or the UE 1034 may use a different spatial domain transmission filter across multiple SRS resources. When the spatial relation information is provided in the configuration, it is applicable across the cells within the validity area. In this case, spatial relation information validity criteria can be defined, and whether/how to determine UE fallback behavior if validity criteria for spatial relation of the configured RS is not met can also be defined. Such definitions (e.g., validity criteria and fallback behaving when the spatial relation information is provided in the configuration) are further described in the present disclosure.

As illustrated in FIG. 13, the UE 1304 communicates with multiple base stations (illustrated as a gNB 1308A, gNB 1308B, gNB 1308C, and gNB 1308C) each providing a cell. Nonetheless, it is possible that the UE 1304 communicates with a base station that provides multiple cells. In this illustration, the UE 1304 is configured with a set of one or more SpatialRelationInfoPos(s) for an SRS resource for positioning. A SpatialRelationInfoPos can be specific to a cell identifier (e.g., be configured for a corresponding cell). Additionally, or alternatively, SpatialRelationInfoPos can be specific to a group of cell identifiers (e.g., be configured for a corresponding cell group).

In an example, the number of SpatialRelationInfoPos(s) can configured per area can depend on the UE capability. In one example, one SpatialRelationInfoPos is configured per cell identifier and/or group of cell identifiers (e.g., the size of the configured set of SpatialRelationInfoPos(s) is one). The single configured SpatialRelationInfoPos can correspond to a single spatial domain transmission filter usable for both FR1 and FR2. In another example, more than one SpatialRelationInfoPos is configured per cell identifier and/or group of cell identifiers (e.g., the size of the configured set of SpatialRelationInfoPos(s) is larger than one). Each configured SpatialRelationInfoPos can correspond to a different spatial domain transmission filter usable for FR2, for instance.

The validity criteria of spatial relation for SRS transmission and UE behavior can be defined as following. If the UE 1304 is in the RRC_INACTIVE state or the RRC_IDLE state and determines that the UE 1304 is not able to accurately measure a number “N” of the configured downlink reference signal in SRS-SpatialRelationInfoPos for a SRS resource for positioning per cell identifier and/or group of cell identifiers, where the downlink reference signal is semi-persistent or periodic, the UE 1304 may fallback to behavior assuming the SRS information is absent or stop transmission of the SRS resource for positioning. The fallback behavior includes the UE 1304 using a fixed spatial domain transmission filter for transmissions of the SRS configured by the higher layer parameter SRS-PosResource across multiple SRS resources or the UE 1034 using a different spatial domain transmission filter across multiple SRS resources. The number “N” can depend on the position method and the number and the UE capability to support a number of SRS-SpatialRelationInfoPos parameters per cell identifier or group of cell identifiers. For example, “N” can be set as “min (position method, supported).”

In an example, “N” is one if only one SRS-SpatialRelationInfoPos is configured. In another example, “N” is three if multiple SRS-SpatialRelationInfoPos are configured and three anchor positions are needed for positioning (e.g., in the case of a triangulation positioning method). In yet another example, “N” can be higher layer configured. For instance, “N” can be set in a SRS-SpatialRelationInfoPos configuration in case the positioning method needs a different number of anchors. Generally, in these examples, if the UE position cannot be measured at a target accuracy (or minimum accuracy) by using “N” of the configured downlink reference signals, the fallback behavior may be followed.

Referring back to FIG. 13, assume that a positioning method 1310 necessitates “M” anchor positions. For instance, in the case of triangulation, “M” may be three such that triangulation can be used involving at least three cells out of the four cells provided by the gNB 1308A through 1308D. Assume that the UE 1304 is able to accurately measure less than “N” configured downlink reference signal. Here, if “N” is less than “M,” the UE can use a fixed or a different spatial domain transmission filter(s) 1330 per the fallback behavior or can stop SRS transmission 1340.

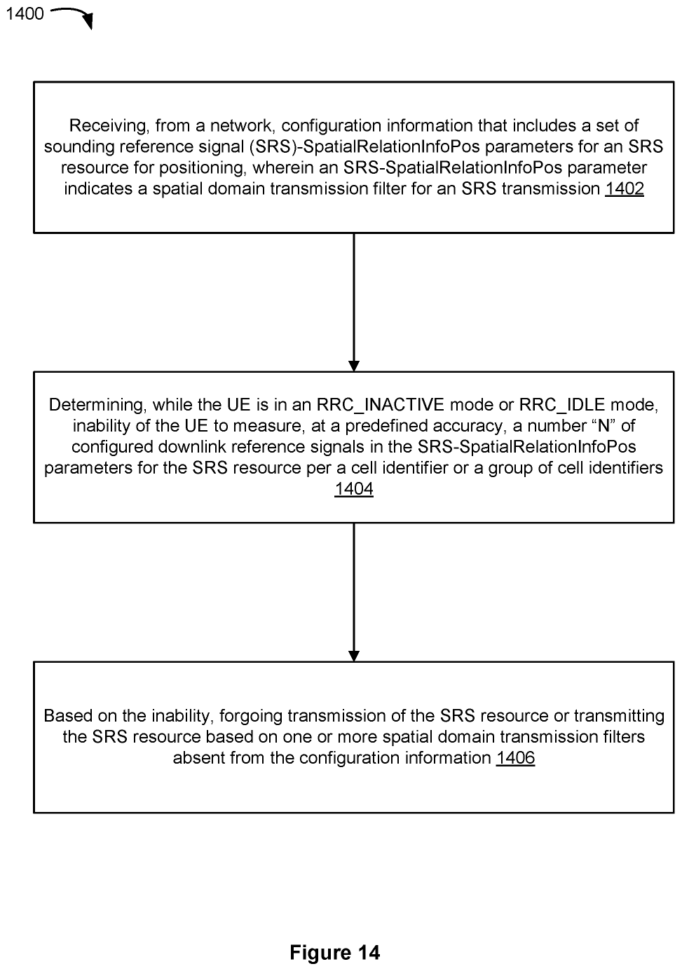

FIG. 14 illustrates another example of an operational flow/algorithmic structure 1400 for user equipment positioning, in accordance with some embodiments. The operational flow/algorithmic structure 1400 can be implemented by a UE, such as any of the UEs described herein, for the transmission of SRS for positioning, where the transmission uses frequency hopping.

In an example, the operational flow/algorithmic structure 1400 includes, at 1402, receiving, from a network, configuration information that includes a set of sounding reference signal (SRS)-SpatialRelationInfoPos parameters for an SRS resource for positioning, wherein an SRS-SpatialRelationInfoPos parameter indicates a spatial domain transmission filter for an SRS transmission.

In an example, the operational flow/algorithmic structure 1400 includes, at 1404, determining, while the UE is in an RRC_INACTIVE state or RRC_IDLE state, inability of the UE to measure, at a predefined accuracy, a number “N” of configured downlink reference signals in the SRS-SpatialRelationInfoPos parameters for the SRS resource per a cell identifier or a group of cell identifiers.

In an example, the operational flow/algorithmic structure 1400 includes, at 1406, based on the inability, forgoing transmission of the SRS resource or transmitting the SRS resource based on one or more spatial domain transmission filters absent from the configuration information.

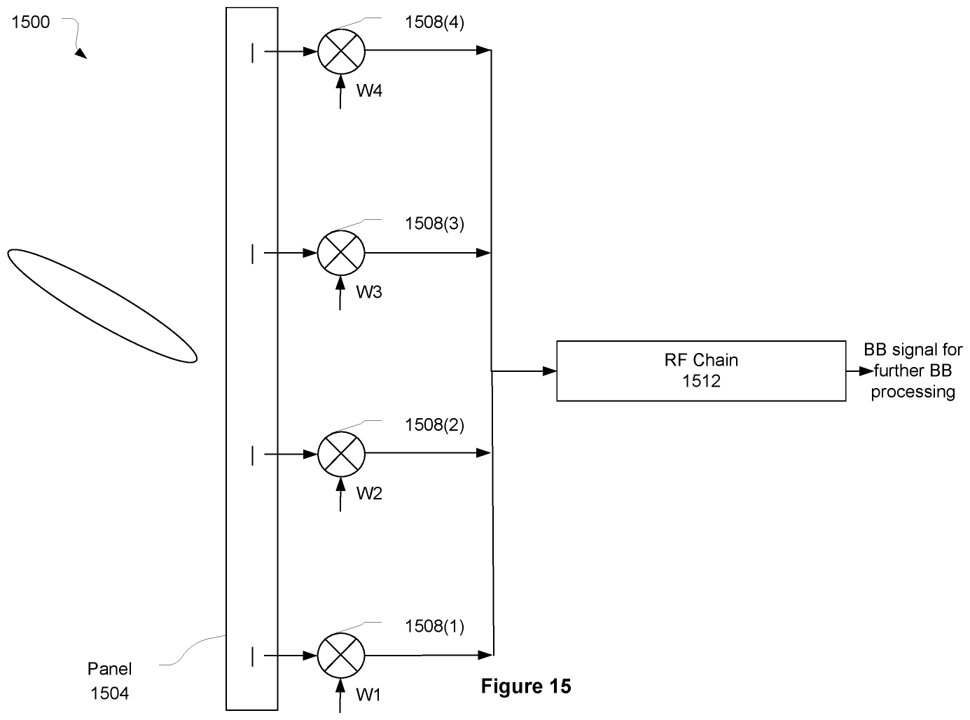

FIG. 15 illustrates receive components 1500 of the UE 104, or the gNB 108 in accordance with some embodiments. The receive components 1500 may include an antenna panel 1504 that includes a number of antenna elements. The panel 1504 is shown with four antenna elements, but other embodiments may include other numbers.

The antenna panel 1504 may be coupled to analog beamforming (BF) components that include a number of phase shifters 1508(1)-1508(4). The phase shifters 1508(1)-1508(4) may be coupled with a radio-frequency (RF) chain 1512. The RF chain 1512 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1508(1)-1508(4) to provide a receive beam at the antenna panel 1504. These BF weights may be determined based on the channel-based beamforming.

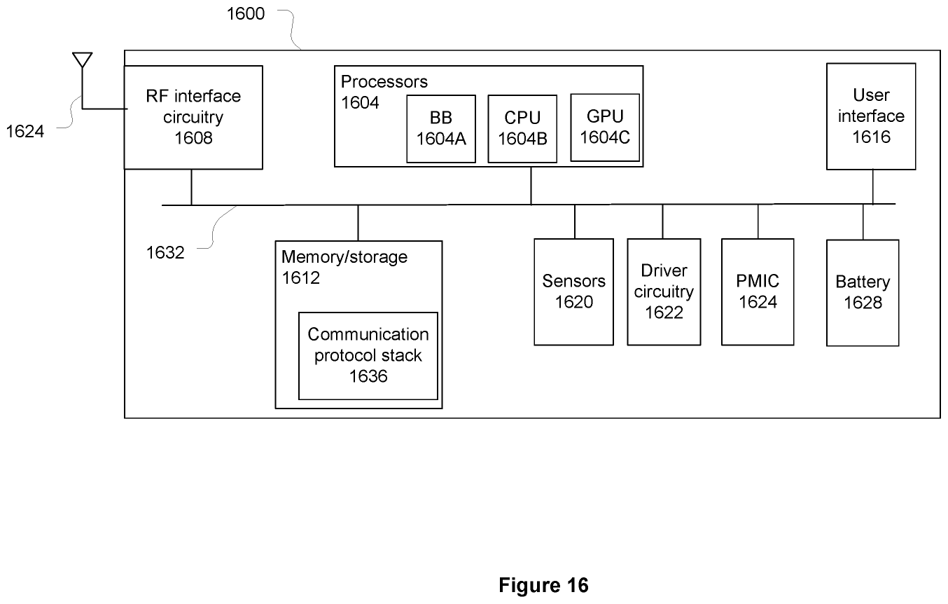

FIG. 16 illustrates a UE 1600 in accordance with some embodiments. The UE 1600 may be similar to and substantially interchangeable with UE 104 of FIG. 1.

Similar to that described above with respect to UE 104, the UE 1600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, and actuators), video surveillance/monitoring devices (for example, cameras, and video cameras), wearable devices, or relaxed-IoT devices. In some embodiments, the UE may be a reduced capacity UE or NR-Light UE.

The UE 1600 may include processors 1604, RF interface circuitry 1608, memory/storage 1612, user interface 1616, sensors 1620, driver circuitry 1622, power management integrated circuit (PMIC) 1624, and battery 1628. The components of the UE 1600 may be implemented as integrated circuits (ICs), portions thereof, discrete electronic devices, or other modules, logic, hardware, software, firmware, or a combination thereof. The block diagram of FIG. 16 is intended to show a high-level view of some of the components of the UE 1600. However, some of the components shown may be omitted, additional components may be present, and different arrangements of the components shown may occur in other implementations.

The components of the UE 1600 may be coupled with various other components over one or more interconnects 1632 which may represent any type of interface, input/output, bus (local, system, or expansion), transmission line, trace, optical connection, etc. that allows various circuit components (on common or different chips or chipsets) to interact with one another.

The processors 1604 may include processor circuitry such as, for example, baseband processor circuitry (BB) 1604A, central processor unit circuitry (CPU) 1604B, and graphics processor unit circuitry (GPU) 1604C. The processors 1604 may include any type of circuitry or processor circuitry that executes or otherwise operates computer-executable instructions, such as program code, software modules, or functional processes from memory/storage 1612 to cause the UE 1600 to perform operations as described herein.

In some embodiments, the baseband processor circuitry 1604A may access a communication protocol stack 1636 in the memory/storage 1612 to communicate over a 3GPP compatible network. In general, the baseband processor circuitry 1604A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1608.

The baseband processor circuitry 1604A may generate or process baseband signals or waveforms that carry information in 3GPP-compatible networks. In some embodiments, the waveforms for NR may be based on cyclic prefix OFDM (CP-OFDM) in the uplink or downlink and discrete Fourier transform spread OFDM (DFT-S-OFDM) in the uplink.

The baseband processor circuitry 1604A may also access group information 1624 from memory/storage 1612 to determine search space groups in which a number of repetitions of a PDCCH may be transmitted.

The memory/storage 1612 may include any type of volatile or non-volatile memory that may be distributed throughout the UE 1600. In some embodiments, some of the memory/storage 1612 may be located on the processors 1604 themselves (for example, L1 and L2 cache), while other memory/storage 1612 is external to the processors 1604 but accessible thereto via a memory interface. The memory/storage 1612 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1608 may include transceiver circuitry and a radio frequency front module (RFEM) that allows the UE 1600 to communicate with other devices over a radio access network. The RF interface circuitry 1608 may include various elements arranged in transmit or receive paths. These elements may include switches, mixers, amplifiers, filters, synthesizer circuitry, control circuitry, etc.

In the receive path, the RFEM may receive a radiated signal from an air interface via an antenna 1624 and proceed to filter and amplify (with a low-noise amplifier) the signal. The signal may be provided to a receiver of the transceiver that down-converts the RF signal into a baseband signal that is provided to the baseband processor of the processors 1604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1624.

In various embodiments, the RF interface circuitry 1608 may be configured to transmit/receive signals in a manner compatible with NR access technologies.

The antenna 1624 may include a number of antenna elements that each convert electrical signals into radio waves to travel through the air and to convert received radio waves into electrical signals. The antenna elements may be arranged into one or more antenna panels. The antenna 1624 may have antenna panels that are omnidirectional, directional, or a combination thereof to enable beamforming and multiple input, multiple output communications. The antenna 1624 may include micro-strip antennas, printed antennas that are fabricated on the surface of one or more printed circuit boards, patch antennas, phased array antennas, etc. The antenna 1624 may have one or more panels designed for specific frequency bands including bands in FR1 or FR2.

The user interface circuitry 1616 includes various input/output (I/O) devices designed to enable user interaction with the UE 1600. The user interface 1616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1600.

The sensors 1620 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lens-less apertures); light detection and ranging sensors; proximity sensors (for example, infrared radiation detector and the like); depth sensors; ambient light sensors; ultrasonic transceivers; microphones or other like audio capture devices; etc.

The driver circuitry 1622 may include software and hardware elements that operate to control particular devices that are embedded in the UE 1600, attached to the UE 1600, or otherwise communicatively coupled with the UE 1600. The driver circuitry 1622 may include individual drivers allowing other components to interact with or control various input/output (I/O) devices that may be present within or connected to the UE 1600. For example, driver circuitry 1622 may include a display driver to control and allow access to a display device, a touchscreen driver to control and allow access to a touchscreen interface, sensor drivers to obtain sensor readings of sensor circuitry 1620 and control and allow access to sensor circuitry 1620, drivers to obtain actuator positions of electro-mechanic components or control and allow access to the electro-mechanic components, a camera driver to control and allow access to an embedded image capture device, or audio drivers to control and allow access to one or more audio devices.

The PMIC 1624 may manage power provided to various components of the UE 1600. In particular, with respect to the processors 1604, the PMIC 1624 may control power-source selection, voltage scaling, battery charging, or DC-to-DC conversion.

In some embodiments, the PMIC 1624 may control, or otherwise be part of, various power saving mechanisms of the UE 1600. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1600 may power down for brief intervals of time and thus save power. If there is no data traffic activity for an extended period of time, then the UE 1600 may transition off to an RRC_Idle state, where it disconnects from the network and does not perform operations such as channel quality feedback, handover, etc. The UE 1600 goes into a very low power state and it performs paging where again it periodically wakes up to listen to the network and then powers down again. The UE 1600 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay, and it is assumed the delay is acceptable.

A battery 1628 may power the UE 1600, although in some examples the UE 1600 may be mounted deployed in a fixed location and may have a power supply coupled to an electrical grid. The battery 1628 may be a lithium-ion battery, a metal-air battery, such as a zinc-air battery, an aluminum-air battery, a lithium-air battery, and the like. In some implementations, such as in vehicle-based applications, the battery 1628 may be a typical lead-acid automotive battery.

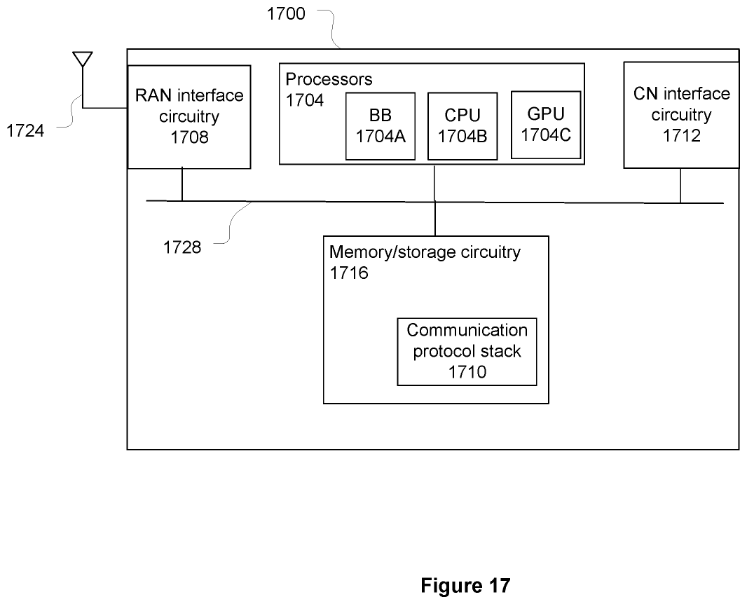

FIG. 17 illustrates a gNB 1700 in accordance with some embodiments. The gNB node 1700 may be similar to and substantially interchangeable with gNB 108. A base station can have the same or similar components as the gNB 1700.

The gNB 1700 may include processors 1704, RF interface circuitry 1708, core network (CN) interface circuitry 1712, and memory/storage circuitry 1716.

The components of the gNB 1700 may be coupled with various other components over one or more interconnects 1728.

The processors 1704, RF interface circuitry 1708, memory/storage circuitry 1716 (including communication protocol stack 1710), antenna 1724, and interconnects 1728 may be similar to like-named elements shown and described with respect to FIG. 15.

The CN interface circuitry 1712 may provide connectivity to a core network, for example, a 5th Generation Core network (5GC) using a 5GC-compatible network interface protocol, such as carrier Ethernet protocols or some other suitable protocol. Network connectivity may be provided to/from the gNB 1700 via a fiber optic or wireless backhaul. The CN interface circuitry 1712 may include one or more dedicated processors or FPGAs to communicate using one or more of the aforementioned protocols. In some implementations, the CN interface circuitry 1712 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

In the following sections, further exemplary embodiments are provided.

Example includes a method implemented by a user equipment (UE), the method comprising: receiving, from a network, configuration information associated with a sounding reference signal for positioning (SRSp) transmission that uses frequency hopping to achieve an effective positioning bandwidth for the SRSp transmission, wherein the UE is a reduced capability (RedCap) UE having a transmission bandwidth, wherein the effective positioning bandwidth is larger than the transmission bandwidth of the RedCap UE; determining a configuration associated with the frequency hopping to transmit an SRSp, wherein the configuration is specific to a plurality of frequency hops or to a frequency hop of the plurality of frequency hops and includes at least one of a window for the SRSp transmission or a collision rule for resolving a signal collision between the SRSp and a non-SRSp signal; and based on the configuration, performing at least one of: upon the configuration including the window, transmitting the SRSp during the window, wherein within a first time duration before a start of the window and within a second time duration after the end of the window, the RedCap UE forgoes signal transmission or reception; or upon the configuration including the collision rule, transmitting the SRSp based on a signal priority, wherein the signal priority is determined at or within the first time duration before a start of the SRSp transmission.

Example 2 incudes a method implemented by a user equipment (UE), the method comprising: receiving, from a network, configuration information that includes a set of sounding reference signal (SRS)-SpatialRelationInfoPos parameters for an SRS resource for positioning, wherein an SRS-SpatialRelationInfoPos parameter indicates a spatial domain transmission filter for an SRS transmission; determining, while the UE is in an RRC_INACTIVE state or RRC_IDLE state, inability of the UE to measure, at a predefined accuracy, a number “N” of configured downlink reference signals in the SRS-SpatialRelationInfoPos parameters for the SRS resource per a cell identifier or a group of cell identifiers; and based on the inability, forgoing transmission of the SRS resource or transmitting the SRS resource based on one or more spatial domain transmission filters absent from the configuration information.

Example 3 includes the method of example and example 2.

Example 4 includes the method of any preceding example, wherein the configuration information indicates the configuration of the window, wherein the configuration indicates a window identifier, a periodicity in slots, an offset of a starting slot, and a time length.

Example 5 includes the method of example 4, wherein the time length includes a number of slots, a number of sub-slots within a slot, or a number of symbols within a slot.

Example 6 includes the method of example 5, wherein the time length includes the number of symbols, wherein the SRSp is transmitted using one or more of the symbols, and wherein a non-SRSp signal is further transmitted using other symbols of the slot.

Example 7 includes the method of example 4, wherein the window is valid for a plurality of cells and is configured relative to a reference cell of the plurality of cells, wherein the reference cell is a primary cell or is a secondary cell configured for positioning.

Example 8 includes the method of example 4, wherein the RedCap UE is configured for the SRSp transmissions during the window only or for the SRPp transmissions during and outside of the window.

Example 9 includes the method of any preceding example, wherein the first time duration corresponds to a first number of symbols, wherein the second time duration corresponds to a second number of symbols, and wherein at least one of the first number of the second number is based on sub-carrier spacing of the SRSp transmission, differs between downlink symbols or channels and uplink symbols or channels, or is based on UE capability of the RedCap UE.

Example 10 includes the method of any preceding example, wherein the collision rule applies to the SRSp transmission outside of the window or applies to the SRSp transmission during the window.

Example 11 includes the method of any preceding example, wherein the collision rule is specific to the frequency hop and indicates whether the SRSp is to be transmitted or dopped upon the signal collision occurring in the frequency hop.

Example 12 includes the method of example 11, wherein the SRSp is transmitted based on the signal priority by at least determining at a number of symbols before the SRSp transmission that the SRSp has a higher signal priority than the non-SRSp signal to be transmitted using the frequency hop and foregoing a transmission of the non-SRSp signal, wherein the number of symbols corresponds to the first time duration.

Example 13 includes the method of any preceding example, wherein the collision rule is specific to the plurality of frequency hops sand indicates whether the SRSp is to be transmitted or dopped upon the signal collision occurring on any one of the plurality of frequency hops.

Example 14 includes the method of example 13, wherein the SRSp is transmitted based on the signal priority by at least determining at a number of symbols before the SRSp transmission that the SRSp has a higher signal priority than the non-SRSp signal to be transmitted using any of the plurality of frequency hops and foregoing a transmission of the non-SRSp signal, wherein the number of symbols corresponds to the first time duration.

Example 15 includes the method of any preceding example, wherein the configuration information indicates relative signal priorities for the collision rule, wherein the same priority signaling or a different priority signaling is indicated for downlink and uplink signals.

Example 16 includes the method of any preceding example, wherein the collision rule applies relative signal priorities that are predefined rather than being included in the configuration information.

Example 17 includes the method of any preceding example, wherein the configuration information indicates the first time window as a number of symbols and the signal priority for the SRSp transmission.

Example 18 includes the method of any preceding example further comprising: receiving a positioning reference signal (PRS) on a downlink channel; determining that the receiving of the PRS uses less than a desired effective positioning bandwidth; and sending, to the network, an indication that less than the desired effective positioning bandwidth is used.

Example 19 includes the method of any preceding example further comprising: receiving a positioning reference signal (PRS) on a downlink channel; and sending, to the network, one or more measurements for contiguous reference signal transmissions and an indication of frequency hops that are combined, wherein the one or more measurements are a single measurement corresponding to the largest contiguous reference signal transmission or a plurality of measurements corresponding to different contiguous reference signal transmissions.

Example 20 includes the method of any preceding example further comprising: receiving a positioning reference signal (PRS) on a downlink channel; and sending, to the network, a per hop reference signal measurement with a location index of the per hop reference signal measurement.

Example 21 includes the method of example 20, wherein the per hop per hop reference signal measurement is sent upon a failure of a reference signal measurement across a desired effective positioning bandwidth.

Example 22 includes the method of any preceding example further comprising: receiving a positioning reference signal (PRS) on a downlink channel; and sending, to the network, a reference signal measurement associated with the plurality of hops and an indication of at least whether the reference signal measurement or the plurality of frequency hops.

Example 23 includes the method of any preceding example further comprising: receiving a positioning reference signal (PRS) on a downlink channel; and sending, to the network, a plurality of reference signal measurements and an indication a corresponding set of frequency hops for each one of the plurality of reference signal measurements.

Example 24 includes the method of any preceding example further comprising: receiving a positioning reference signal (PRS) on a downlink channel; and sending, to the network, a plurality of per frequency hop reference signal measurements and an indication of a corresponding frequency hop for each one of the plurality of per frequency hop reference signal measurements.

Example 25 includes the method of any preceding example further comprising: receiving a positioning reference signal (PRS) on a downlink channel; and sending, to the network, a plurality of per frequency hop reference signal measurements and an indication of a correspondence between each frequency hop and each one of the plurality of per frequency hop reference signal measurements.

Example 26 includes the method of any preceding example further comprising: receiving a positioning reference signal (PRS) on a downlink channel; and sending, to the network, a plurality of per frequency hop reference signal measurements, wherein a default value of a per frequency hop reference signal measurement indicates that no reference signal measurement was generated for a corresponding frequency hop.

Example 27 includes the method of any preceding example further comprising: determining a positioning reference signal (PRS) configuration that uses the frequency hopping, wherein use of the frequency hopping is based on the UE being a RedCap UE or is based on the PRS configuration and the effective positing bandwidth; and receiving, from the network, a PRS on a downlink channel based on the PRS configuration.

Example 28 includes the method of any preceding example, wherein the PRS configuration is determined based on an information element that includes a PRS configuration identifier, an indication of whether the frequency hopping is to be used, and an indication of the effective positioning bandwidth.

Example 29 includes the method of any preceding example wherein the PRS is requested based on an information element that includes an indication of whether the frequency hopping is to be used and an indication of the effective positioning bandwidth.

Example 30 includes the method of any preceding example, wherein the PRS is UE-requested or location management function (LMF)-requested based on PRS parameters that include an indication of the effective positioning bandwidth, a frequency hopping overlap, a number of frequency hops, an indication of whether intra-slot hopping is to be used, and an indication of whether inter-slot hopping is to be used.

Example 31 includes the method of example 30, wherein the set of SRS-SpatialRelationInfoPos parameters is configured for the cell identifier or the group of cell identifiers.

Example 32 includes the method of example 30, wherein the set of SRS-SpatialRelationInfoPos parameters is configured per area based on UE capability, wherein one SRS-SpatialRelationInfoPos parameter is configured per cell identifier or group of cell identifiers.

Example 33 includes the method of example 30, wherein the set of SRS-SpatialRelationInfoPos parameters is configured per area based on UE capability, wherein more than one SRS-SpatialRelationInfoPos parameter is configured per cell identifier or group of cell identifiers.

Example 34 includes the method of example 30, wherein the number “N” is based on a used positioning method and UE capability to support a number of SRS-SpatialRelationInfoPos parameters per cell identifier or group of cell identifiers.

Example 35 includes the method of example 34, wherein the number “N” is equal to one if only one SRS-SpatialRelationInfoPos parameter is configured in the set of SRS-SpatialRelationInfoPos parameters.

Example 36 includes the method of example 34, wherein the number “N” is equal to three if more than one SRS-SpatialRelationInfoPos parameter is configured in the set of SRS-SpatialRelationInfoPos parameters and the used positioning method uses at least three anchor positions.

Example 37 includes the method of example 34, wherein the number “N” is configured in the configuration information.

Example 38 includes a user equipment (UE) comprising: one or more processors; and one or more memory storing instructions that, upon execution by the one or more processors, configure the UE to perform the method of any preceding example.

Example 39 includes one or more computer-readable media storing instructions that, when executed on a user equipment (UE), cause the UE to perform operations comprising those of the method of any preceding example.

Example 40 includes a device comprising means to perform one or more elements of a method described in or related to any of the preceding examples.

Example 41 includes one or more non-transitory computer-readable media comprising instructions to cause a device, upon execution of the instructions by one or more processors of the device, to perform one or more elements of a method described in or related to any of the preceding examples.

Example 42 includes a device comprising logic, modules, or circuitry to perform one or more elements of a method described in or related to any of the preceding examples.

Example 43 includes a device comprising: one or more processors and one or more computer-readable media comprising instructions that, when executed by the one or more processors, cause the one or more processors to perform one or more elements of a method described in or related to any of the preceding examples.

Example 44 includes a system comprising means to perform one or more elements of a method described in or related to any of the preceding examples.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations, and modifications will become apparent to those skilled in the art once the above disclosure is fully appreciated. It is intended that the following claims be interpreted to embrace all such variations and modifications.

Applicant hereby claims:

1. A method comprising:
processing configuration information associated with a sounding reference signal for positioning (SRSp) transmission that uses frequency hopping to achieve an effective positioning bandwidth for the SRSp transmission, wherein the configuration information is received from a network, and wherein the effective positioning bandwidth is larger than a transmission bandwidth of a reduced capability (RedCap) UE;
determining a configuration associated with the frequency hopping to transmit an SRSp, wherein the configuration is specific to a plurality of frequency hops or to a frequency hop of the plurality of frequency hops and includes at least one of a window for the SRSp transmission or a collision rule for resolving a signal collision between the SRSp and a non-SRSp signal; and
based on the configuration, causing at least one of:
upon the configuration including the window, transmission of the SRSp during the window, wherein within a first time duration before a start of the window and within a second time duration after an end of the window, signal transmission or reception is foregone; or
upon the configuration including the collision rule, transmission of the SRSp based on a signal priority, wherein the signal priority is determined at or within the first time duration before a start of the SRSp transmission.

2. The method of claim 1 further comprising:
processing a positioning reference signal (PRS) received on a downlink channel;
determining that receiving the PRS uses less than a desired effective positioning bandwidth; and
causing transmission, to the network, of an indication that less than the desired effective positioning bandwidth is used.

3. The method of claim 1 further comprising:
processing a positioning reference signal (PRS) received on a downlink channel; and
causing transmission, to the network, of one or more measurements for contiguous reference signal transmissions and an indication of frequency hops that are combined, wherein the one or more measurements are a single measurement corresponding to the largest contiguous reference signal transmission or a plurality of measurements corresponding to different contiguous reference signal transmissions.

4. The method of claim 1 further comprising:
processing a positioning reference signal (PRS) received on a downlink channel; and
causing transmission, to the network, of a per hop reference signal measurement with a location index of the per hop reference signal measurement.

5. The method of claim 1 further comprising:
processing a positioning reference signal (PRS) received on a downlink channel; and
causing transmission, to the network, of a reference signal measurement associated with the plurality of frequency hops and an indication of at least whether the reference signal measurement or the plurality of frequency hops.

6. The method of claim 1 further comprising:
processing a positioning reference signal (PRS) received on a downlink channel; and
causing transmission, to the network, of a plurality of reference signal measurements and an indication a corresponding set of frequency hops for each one of the plurality of reference signal measurements.

7. The method of claim 1 further comprising:
processing a positioning reference signal (PRS) received on a downlink channel; and
causing transmission, to the network, of a plurality of per frequency hop reference signal measurements and an indication of a corresponding frequency hop for each one of the plurality of per frequency hop reference signal measurements.

8. The method of claim 1 further comprising:
processing a positioning reference signal (PRS) received on a downlink channel; and
causing transmission, to the network, of a plurality of per frequency hop reference signal measurements and an indication of a correspondence between each frequency hop and each one of the plurality of per frequency hop reference signal measurements.

9. The method of claim 1 further comprising:
processing a positioning reference signal (PRS) received on a downlink channel; and
causing transmission, to the network, of a plurality of per frequency hop reference signal measurements, wherein a default value of a per frequency hop reference signal measurement indicates that no reference signal measurement was generated for a corresponding frequency hop.

10. The method of claim 1 further comprising:
processing a positioning reference signal (PRS) configuration that uses the frequency hopping, wherein use of the frequency hopping is based on the RedCap UE or is based on the PRS configuration and the effective positing bandwidth; and
processing a PRS received from the network on a downlink channel based on the PRS configuration.

11. An apparatus comprising:
processing circuitry configured to:
process configuration information associated with a sounding reference signal for positioning (SRSp) transmission that uses frequency hopping to achieve an effective positioning bandwidth for the SRSp transmission, wherein the configuration information is received from a network, and wherein the effective positioning bandwidth is larger than a transmission bandwidth of a reduced capability (RedCap) UE;
determine a configuration associated with the frequency hopping to transmit an SRSp, wherein the configuration is specific to a plurality of frequency hops or to a frequency hop of the plurality of frequency hops and includes at least one of a window for the SRSp transmission or a collision rule for resolving a signal collision between the SRSp and a non-SRSp signal; and
based on the configuration, cause at least one of:
upon the configuration including the window, transmission of the SRSp during the window, wherein within a first time duration before a start of the window and within a second time duration after an end of the window, signal transmission or reception is foregone; or
upon the configuration including the collision rule, transmission of the SRSp based on a signal priority, wherein the signal priority is determined at or within the first time duration before a start of the SRSp transmission.

12. The apparatus of claim 11, wherein the configuration information indicates the configuration of the window, wherein the configuration indicates a window identifier, a periodicity in slots, an offset of a starting slot, and a time length.

13. The apparatus of claim 11, wherein the first time duration corresponds to a first number of symbols, wherein the second time duration corresponds to a second number of symbols, and wherein at least one of the first number of the second number is based on sub-carrier spacing of the SRSp transmission, differs between downlink symbols or channels and uplink symbols or channels, or is based on UE capability.

14. The apparatus of claim 11, wherein the collision rule applies to the SRSp transmission outside of the window or applies to the SRSp transmission during the window.

15. The apparatus of claim 11, wherein the collision rule is specific to the frequency hop and indicates whether the SRSp is to be transmitted or dopped upon the signal collision occurring in the frequency hop or any one of the plurality of frequency hops.

16. A method comprising:
processing configuration information that is received from a network and that includes a set of sounding reference signal (SRS)-SpatialRelationInfoPos parameters for an SRS resource for positioning, wherein an SRS-SpatialRelationInfoPos parameter indicates a spatial domain transmission filter for an SRS transmission;
determining, while operating in an RRC_INACTIVE state or RRC_IDLE state, inability to measure, at a predefined accuracy, a number “N” of configured downlink reference signals in the SRS-SpatialRelationInfoPos parameters for the SRS resource per a cell identifier or a group of cell identifiers; and
based on the inability, forgoing transmission of the SRS resource or causing transmission of the SRS resource based on one or more spatial domain transmission filters absent from the configuration information.

17. The method of claim 16, wherein the set of SRS-SpatialRelationInfoPos parameters is configured for the cell identifier or the group of cell identifiers.

18. The method of claim 16, wherein the set of SRS-SpatialRelationInfoPos parameters is configured per area based on capability information, wherein one SRS-SpatialRelationInfoPos parameter is configured per cell identifier or group of cell identifiers.

19. The method of claim 16, wherein the set of SRS-SpatialRelationInfoPos parameters is configured per area based on capability information, wherein more than one SRS-SpatialRelationInfoPos parameter is configured per cell identifier or group of cell identifiers.

20. The method of claim 16, wherein the number “N” is based on a used positioning method and capability to support a number of SRS-SpatialRelationInfoPos parameters per cell identifier or group of cell identifiers.
